(19) United States
(12) Patent Application Publication
(10) Pub. No.: US 2023/0064741 A1
(43) Pub. Date: Mar. 2, 2023

(54) OPTICAL IMAGING SYSTEM

(71) Applicant: SAMSUNG ELECTRO-MECHANICS CO., LTD., Suwon-si (KR)

(72) Inventors: Dong Hyuk JANG, Suwon-si (KR); So Mi YANG, Suwon-si (KR); Kil Soo SHIN, Suwon-si (KR)

(73) Assignee: SAMSUNG ELECTRO-MECHANICS CO., LTD., Suwon-si (KR)

(21) Appl. No.: 17/673,113

(22) Filed: Feb. 16, 2022

(30) Foreign Application Priority Data
Aug. 24, 2021 (KR) 10-2021-0111843

(51) Int. Cl. G02B 13/00; G02B 9/64

(52) U.S. Cl. CPC G02B 13/0045; G02B 9/64

(57) ABSTRACT

An optical imaging system includes a first lens, a second lens, a third lens, a fourth lens, a fifth lens, a sixth lens and a seventh lens, disposed in order from an object side, wherein the first lens has positive refractive power, and the second lens has negative refractive power, and wherein 0.5 < TTL/(2×IMG HT) < 0.67 is satisfied, where TTL is a distance from an object-side surface of the first lens to an imaging plane on an optical axis, and IMG HT is half a diagonal length of the imaging plane.

### CROSS-REFERENCE TO RELATED APPLICATIONS

This application claims the benefit under 35 USC 119(a) of Korean Patent Application No. 10-2021-0111843 filed on Aug. 24, 2021, in the Korean Intellectual Property Office, the entire disclosure of which is incorporated herein by reference for all purposes.

### BACKGROUND

### 1. Field

Example embodiments of the present disclosure relate to an optical imaging system.

### 2. Description of the Background

A portable terminal may include a camera including an optical imaging system with a plurality of lenses to perform video calls and image capturing.

As the function occupied by the camera in the portable terminal has gradually increased, the demand for a camera for a portable terminal having a high resolution has increased.

An image sensor having a high pixel count (e.g., 13 million to 100 million pixels, etc.) may be employed in a camera for a portable terminal to implement improved picture quality.

Also, since a portable terminal may be designed to have a small size, a camera for a portable terminal may also be designed to have a reduced size, and thus, it may be desirable to develop an optical imaging system having a reduced size and which may implement high resolution.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens, a second lens, a third lens, a fourth lens, a fifth lens, a sixth lens and a seventh lens, disposed in order from an object side, wherein the first lens has positive refractive power, and the second lens has negative refractive power, and wherein 0.5 < TTL/(2xIMG HT) < 0.67 is satisfied, where TTL is a distance from an object-side surface of the first lens to an imaging plane on an optical axis, and IMG HT is half a diagonal length of the imaging plane.

IMG HT may be greater than 4.5 mm (millimeters) and less than 6.5 mm.

TTL/ΣCT may be less than 2.97, where ΣCT is a sum of thicknesses of the first to seventh lenses on the optical axis.

f/f4 may be greater than -0.2 and less than 0, where f is a total focal length of the optical imaging system, and f4 is a focal length of the fourth lens.

v1-v2 may be less than 38 and n2+n4 may be greater than 3.3, where v1 is an Abbe number of the first lens, v2 is an Abbe number of the second lens, n2 is a refractive index of the second lens, and n4 is a refractive index of the fourth lens.

TTL/f may be less than 1.205 and BFL/f may be less than 0.21, where BFL is a distance from an image-side surface of the seventh lens to the imaging plane on the optical axis.

CT4/f4 may be greater than -0.02 and less than 0, where CT4 is a thickness of the fourth lens on the optical axis.

R8/f4 may be greater than -0.5 and less than 0, where R8 is a radius of curvature of an image-side surface of the fourth lens.

SWG42 may be greater than -20° and less than or equal to -2.9°, where SWG42 is a sweep angle at a maximum effective diameter of an image-side surface of the fourth lens.

SWG41_0.3 may be greater than 0° and less than 1.1°, where SWG41_0.3 is a sweep angle at a point of a maximum effective diameter x 0.3 of an object-side surface of the fourth lens.

SWG42_0.2 may be greater than -0.5° and less than 0.6°, where SWG42_0.2 is a sweep angle of a point of a maximum effective diameter x 0.2 of an image-side surface of the fourth lens.

SWG31_0.5 may be greater than -3° and less than or equal to 3°, where SWG31_0.5 is a sweep angle at a point of a maximum effective diameter x 0.5 of an object-side surface of the third lens.

SWG31_0.2 may be greater than -1° and less than 2°, where SWG31_0.2 is a sweep angle of a point of a maximum effective diameter x 0.2 of an object-side surface of the third lens.

|f1/f2| may be greater than 0.3 and less than 0.45, where f1 is a focal length of the first lens, and f2 is a focal length of the second lens.

|f345| may be greater than 20 mm and less than 120 mm and 4 < |f345|/f may be greater than 4 and less than 25, where f345 is a combined focal length of the third to fifth lenses.

The third lens may have positive refractive power, the fourth lens may have negative refractive power, the fifth lens may have negative refractive power, the sixth lens may have positive refractive power, and the seventh lens may have negative refractive power.

In another general aspect, an optical imaging system includes a first lens having positive refractive power, a second lens having negative refractive power, a third lens having refractive power, a fourth lens having refractive power, a fifth lens having refractive power, a sixth lens having positive refractive power and a concave image-side surface, and a seventh lens having refractive power and a concave object-side surface, wherein the first lens, the second lens, the third lens, the fourth lens, the fifth lens, the sixth lens and the seventh lens are disposed in this order from an object side, and wherein -0.2 < f/f4 < 0 is satisfied, where f is a total focal length of the optical imaging system, and f4 is a focal length of the fourth lens.

TTL/(2×IMG HT) may be greater than 0.5 and less than 0.67.

In another general aspect, an optical imaging system includes a first lens having positive refractive power, a second lens having negative refractive power and a concave object-side surface, a third lens having refractive power, a fourth lens having refractive power, a fifth lens having refractive power, a sixth lens having refractive power, and a seventh lens having refractive power, wherein the first lens, the second lens, the third lens, the fourth lens, the fifth lens, the sixth lens and the seventh lens are disposed in this order from an object side, and wherein v1-v2 < 38 and n2+n4 > 3.3 are satisfied, where v1 is an Abbe number of the first lens, v2 is an Abbe number of the second lens, n2 is a refractive index of the second lens, and n4 is a refractive index of the fourth lens.

Other features and aspects will be apparent from the following detailed description, the drawings, and the claims.

### BRIEF DESCRIPTION OF DRAWINGS

FIG. 1 is a diagram illustrating an optical imaging system according to a first example embodiment of the present disclosure.

FIG. 2 is a diagram illustrating aberration properties of the optical imaging system illustrated in FIG. 1.

FIG. 3 is a diagram illustrating an optical imaging system according to a second example embodiment of the present disclosure.

FIG. 4 is a diagram illustrating aberration properties of the optical imaging system illustrated in FIG. 3.

FIG. 5 is a diagram illustrating an optical imaging system according to a third example embodiment of the present disclosure.

FIG. 6 is a diagram illustrating aberration properties of the optical imaging system illustrated in FIG. 5.

FIG. 7 is a diagram illustrating an optical imaging system according to a fourth example embodiment of the present disclosure.

FIG. 8 is a diagram illustrating aberration properties of the optical imaging system illustrated in FIG. 7.

FIG. 9 is a diagram illustrating an optical imaging system according to a fifth example embodiment of the present disclosure.

FIG. 10 is a diagram illustrating aberration properties of the optical imaging system illustrated in FIG. 9.

FIG. 11 is a diagram illustrating an optical imaging system according to a sixth example embodiment of the present disclosure.

FIG. 12 is a diagram illustrating aberration properties of the optical imaging system illustrated in FIG. 11.

FIG. 13 is a diagram illustrating an optical imaging system according to a seventh example embodiment of the present disclosure.

FIG. 14 is a diagram illustrating aberration properties of the optical imaging system illustrated in FIG. 13.

FIG. 15 is a diagram illustrating an optical imaging system according to an eighth example embodiment of the present disclosure.

FIG. 16 is a diagram illustrating aberration properties of the optical imaging system illustrated in FIG. 15.

FIG. 17 is a diagram illustrating a sweep angle in a predetermined position on a lens surface.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

Hereinafter, while example embodiments of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element’s relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An effective aperture radius of a lens surface is a radius of a portion of the lens surface through which light actually passes, and is not necessarily a radius of an outer edge of the lens surface. An object-side surface of a lens and an image-side surface of the lens may have different effective aperture radiuses.

Stated another way, an effective aperture radius of a lens surface is a distance in a direction perpendicular to an optical axis of the lens surface between the optical axis of the lens surface and a marginal ray of light passing through the lens surface.

One or more example embodiments of the present disclosure provide an optical imaging system which may implement high resolution, and which may have a reduced length.

In the lens diagrams, a thickness, a size, and a shape of the lens may be exaggerated, and in particular, the shape of a spherical or aspherical surface presented in the lens diagram is merely an example and is not limited thereto.

The first lens may refer to a lens most adjacent to an object-side surface, and a seventh lens may refer to a lens most adjacent to an imaging plane (or an image sensor).

Also, in each lens, the first surface may refer to a surface adjacent to an object side (or may refer to an object-side surface), and the second surface may refer to a surface adjacent to an image side (or may refer to an image-side surface). Also, in the example embodiment, a radius of curvature, a thickness, a distance, and a focal length of the lens are indicated in millimeters (mm), and a field of view is indicated in degrees.

In the description of the shape of each lens, the configuration in which one surface is convex indicates that a paraxial region portion of the surface is convex, the configuration in which one surface is concave indicates that a paraxial region portion of the surface is concave, and the configuration in which one surface is flat indicates that a paraxial region portion of the surface is flat. Thus, when one surface of the lens is described as being convex, the edge portion of the lens may be concave. Similarly, when one surface of the lens is described as being concave, the edge portion of the lens may be convex. Also, when one surface of the lens is described as being flat, the edge portion of the lens may be convex or concave.

The paraxial region may refer to a narrow region adjacent to the optical axis.

The imaging plane may refer to a virtual plane on which a focus is formed by the optical imaging system. Alternatively, the imaging plane may refer to one surface of the image sensor on which light is received.

The optical imaging system in an example embodiment may include seven lenses.

For example, the optical imaging system in an example embodiment may include a first lens, a second lens, a third lens, a fourth lens, a fifth lens, a sixth lens, and a seventh lens arranged in order from an object side. The first to seventh lenses may be spaced apart from each other by predetermined distances along the optical axis.

However, the optical imaging system in an example embodiment may not only include seven lenses, and may further include other components if desired.

For example, the optical imaging system may further include an image sensor for converting an image of an incident subject into an electrical signal.

Also, the optical imaging system may further include an infrared filter (hereinafter, referred to as a “filter”) for blocking infrared rays. The filter may be disposed between the seventh lens and the image sensor.

Also, the optical imaging system may further include a stop for adjusting the amount of light.

The first to seventh lenses included in the optical imaging system in an example embodiment may be formed of a plastic material.

Also, at least one of the first to seventh lenses may have an aspherical surface. Also, each of the first to seventh lenses may have at least one aspherical surface.

That is, at least one of the first and second surfaces of the first to seventh lenses may be aspherical. The aspherical surfaces of the first to seventh lenses may be expressed by Equation 1.

$$\begin{matrix}Z = \frac{c {Y}^{2}}{1 + \sqrt{1 - \left(1 + K\right) {c}^{2} {Y}^{2}}} + A {Y}^{4} + B {Y}^{6} + \\ C {Y}^{8} + D {Y}^{10} + E {Y}^{12} + F {Y}^{14} + G {Y}^{16} + H {Y}^{18} + J {Y}^{20} + \\ L {Y}^{22} + M {Y}^{24} + N {Y}^{26} + O {Y}^{28} + P {Y}^{30} ...\end{matrix}$$

In Equation 1, c is a curvature (a reciprocal of a radius of curvature) of the lens, K is a conic constant, and Y is a distance from an arbitrary point on the aspherical surface of the lens to the optical axis. Also, constants A to H, J, and L to P are aspheric coefficients. Z is a distance from an arbitrary point on the aspherical surface of the lens to an apex of the aspherical surface.

The optical imaging system including the first to seventh lenses may have positive/negative/positive/negative/negative/positive/negative refractive power in order from the object side.

The optical imaging system in an example embodiment may satisfy at least one of conditional expressions as below:
(Conditional Expression 1) TTL/ΣCT < 2.97
(Conditional Expression 2) -0.2 < f/f4 < 0
(Conditional Expression 3) v1-v2 < 38
(Conditional Expression 4) TTL/f < 1.205
(Conditional Expression 5) n2+n4 > 3.3
(Conditional Expression 6) BFL/f < 0.21
(Conditional Expression 7) -0.02 < CT4/f4 < 0
(Conditional Expression 8) -0.5 < R8/f4 < 0
(Conditional Expression 9) -20° < SWG42 ≤ -2.9°
(Conditional Expression 10) 0° < SWG41_0.3 < 1.1°
(Conditional Expression 11) -0.5° < SWG42_0.2 < 0.6°
(Conditional Expression 12) -3° < SWG31_0.5 ≤ 3°
(Conditional Expression 13) -1° < SWG31_0.2 < 2°
(Conditional Expression 14) 0.5 < TTL/(2xIMG HT) < 0.67
(Conditional Expression 15) 4.5 mm < IMG HT < 6.5 mm
(Conditional Expression 16) 0.3 < |f1/f2| < 0.45
(Conditional Expression 17) 20 mm < |f345| < 120 mm
(Conditional Expression 18) 4 < |f345|/f < 25

In the conditional expressions, f is a total focal length of the optical imaging system, f1 is a focal length of the first lens, f2 is a focal length of the second lens, f3 is a focal length of the third lens, f4 is a focal length of the fourth lens, f5 is a focal length of the fifth lens, and f345 is a combined focal length of the third to fifth lenses.

v1 is an Abbe number of the first lens, v2 is an Abbe number of the second lens, n2 is a refractive index of the second lens, and n4 is a refractive index of the fourth lens.

TTL is a distance from the object-side surface of the first lens to the imaging plane on the optical axis, and BFL is a distance from the image-side surface of the seventh lens to the imaging plane on the optical axis.

ΣCT is a sum of thicknesses of the lenses on the optical axis, and CT4 is the thickness of the fourth lens on the optical axis.

R8 is a radius of curvature of the image-side surface of the fourth lens, and IMG HT is half a diagonal length of the imaging plane.

SWG31_0.2 is a sweep angle at a point of a maximum effective diameter × 0.2 of the object-side surface of the third lens, and SWG31_0.5 is a sweep angle at a point of the maximum effective diameter × 0.5 of the object-side surface of the third lens.

SWG41_0.3 is a sweep angle at a point of a maximum effective diameter × 0.3 of the object-side surface of the fourth lens, SWG42_0.2 is a sweep angle at a point of a maximum effective diameter × 0.2 of the image-side surface of the fourth lens, and SWG42 is a sweep angle at a point of a maximum effective diameter of the image-side surface of the fourth lens.

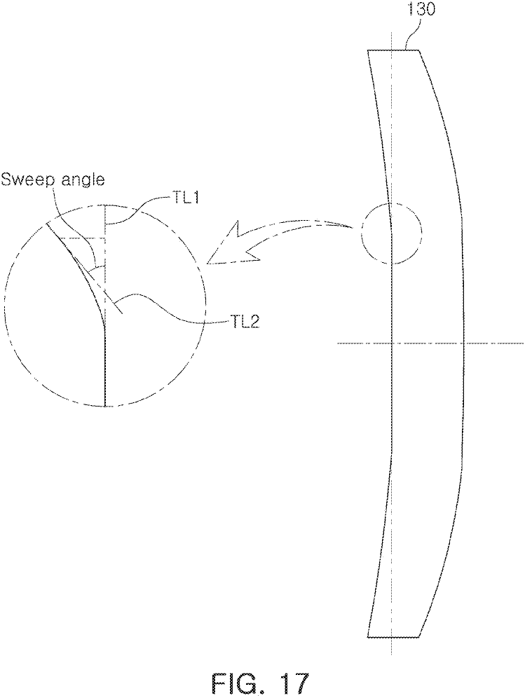

Referring to FIG. 17, a sweep angle at a specific position on the lens surface is illustrated. For example, the sweep angle at a specific position on the object-side surface of the third lens may be defined as an angle between a normal TL1 at the apex of the object-side surface and a normal TL2 at the specific position.

When the object-side surface of the lens is convex, the sweep angle may have a positive value, and when the object-side surface of the lens is concave, the sweep angle may have a negative value.

Also, when the image-side surface of the lens is convex, the sweep angle may have a negative value, and when the image-side surface of the lens is concave, the sweep angle may have a positive value.

The first to seventh lenses included in the optical imaging system in an example embodiment will be described.

The first lens may have positive refractive power. Also, the first lens may have a meniscus shape convex toward the object side. In greater detail, the first surface of the first lens may be convex, and the second surface of the first lens may be concave.

At least one of the first surface and the second surface of the first lens may be aspherical. For example, both surfaces of the first lens may be aspherical.

The second lens may have negative refractive power. Also, the second lens may have a meniscus shape convex toward the object side. In greater detail, the first surface of the second lens may be convex, and the second surface of the second lens may be concave.

Alternatively, both surfaces of the second lens may be concave. In greater detail, the first surface and the second surface of the second lens may be concave.

At least one of the first surface and the second surface of the second lens may be aspherical. For example, both surfaces of the second lens may be aspherical.

The third lens may have positive refractive power. Also, the third lens may have a meniscus shape convex toward the image side. In greater detail, the first surface of the third lens may be concave, and the second surface of the third lens may be convex.

Alternatively, the third lens may have a meniscus shape convex toward the object side. In greater detail, the first surface of the third lens may be convex, and the second surface of the third lens may be concave.

At least one of the first surface and the second surface of the third lens may be aspherical. For example, both surfaces of the third lens may be aspherical.

The fourth lens may have negative refractive power. Also, the fourth lens may have a meniscus shape convex toward the object side. In greater detail, the first surface of the fourth lens may be convex, and the second surface of the fourth lens may be concave.

At least one of the first surface and the second surface of the fourth lens may be aspherical. For example, both surfaces of the fourth lens may be aspherical.

At least one inflection point may be formed on at least one of the first surface and the second surface of the fourth lens. For example, the first surface of the fourth lens may be convex in the paraxial region and may be concave in a portion other than the paraxial region. The second surface of the fourth lens may be concave in the paraxial region and may be convex in a portion other than the paraxial region.

The fifth lens may have negative refractive power. Also, the fifth lens may have a meniscus shape convex toward the object side. In greater detail, the first surface of the fifth lens may be convex in the paraxial region, and the second surface of the fifth lens may be concave in the paraxial region.

At least one of the first surface and the second surface of the fifth lens may be aspherical. For example, both surfaces of the fifth lens may be aspherical.

At least one inflection point may be formed on at least one of the first surface and the second surface of the fifth lens. For example, the first surface of the fifth lens may be convex in the paraxial region and may be concave in a portion other than the paraxial region. The second surface of the fifth lens may be concave in the paraxial region and may be convex in a portion other than the paraxial region.

The sixth lens may have positive refractive power. Also, the sixth lens may have a meniscus shape convex toward the object side. In greater detail, the first surface of the sixth lens may be convex in the paraxial region, and the second surface may be concave in the paraxial region.

At least one of the first surface and the second surface of the sixth lens may be aspherical. For example, both surfaces of the sixth lens may be aspherical.

At least one inflection point may be formed on at least one of the first surface and the second surface of the sixth lens. For example, the first surface of the sixth lens may be convex in the paraxial region and may be concave in a portion other than the paraxial region. The second surface of the sixth lens may be concave in the paraxial region and may be convex in a portion other than the paraxial region.

The seventh lens may have negative refractive power. Also, both surfaces of the seventh lens may be concave. In greater detail, the first surface and the second surface of the seventh lens may be concave in the paraxial region.

At least one of the first surface and the second surface of the seventh lens may be aspherical. For example, both surfaces of the seventh lens may be aspherical.

Also, at least one inflection point may be formed on at least one of the first surface and the second surface of the seventh lens. For example, the first surface of the seventh lens may be concave in the paraxial region and may be convex in a portion other than the paraxial region. The second surface of the seventh lens may be concave in the paraxial region and may be convex in a portion other than the paraxial region.

Each of the first to fifth lenses may be formed of a plastic material having optical properties different from those of adjacent lenses.

At least two lenses among the first to seventh lenses may have a refractive index greater than 1.66.

A lens having negative refractive power among the first to fourth lenses may have a refractive index greater than 1.66. For example, the second lens and the fourth lens may have negative refractive power and a refractive index greater than 1.66.

The absolute value of the focal length of each of the third to fifth lenses may be greater than the absolute value of the focal lengths of the other lenses.

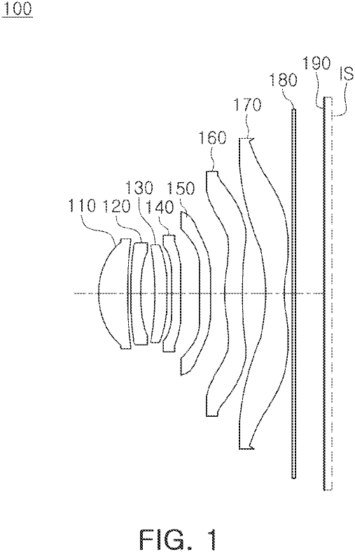

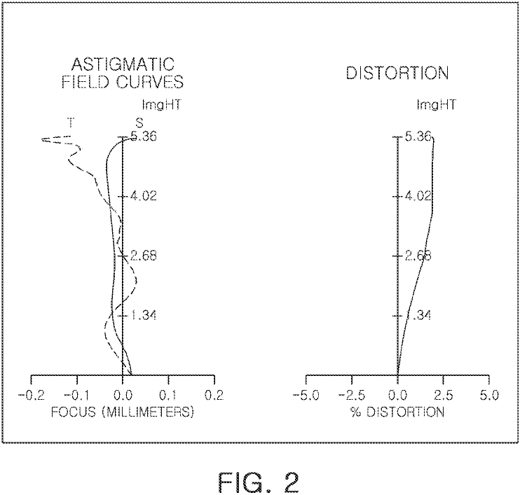

An optical imaging system according to a first example embodiment will be described with reference to FIGS. 1 and 2.

The optical imaging system 100 in the first example embodiment may include an optical system including a first lens 110, a second lens 120, a third lens 130, a fourth lens 140, a fifth lens 150, a sixth lens 160, and a seventh lens 170, and may further include a filter 180 and an image sensor IS.

The optical imaging system 100 in the first example embodiment may form a focus on an imaging plane 190. The imaging plane 190 may refer to a surface on which a focus is formed by the optical imaging system. For example, the imaging plane 190 may refer to one surface of the image sensor IS on which light is received.

The lens properties (a radius of curvature, a thickness of the lens or a distance between the lenses, a refractive index, an Abbe number, and a focal length) of each lens are listed in Table 1.

Table 1

| | | | | | | |
|---|---|---|---|---|---|---|
| Surface No. | Note | Radius of curvature | Thickness or distance | Refractive index | Abbe number | Focal length |
| S1 | First lens | 1.98 | 0.800 | 1.544 | 56.1 | 4.56 |
| S2 | | 8.16 | 0.080 | | | |
| S3 | Second lens | 18.44 | 0.276 | 1.671 | 19.4 | -13.68 |
| S4 | | 6.14 | 0.354 | | | |
| S5 | Third lens | -29.53 | 0.340 | 1.567 | 38.0 | 59.86 |
| S6 | | -15.91 | 0.128 | | | |
| S7 | Fourth lens | 19.62 | 0.250 | 1.671 | 19.4 | -68.90 |
| S8 | | 13.75 | 0.510 | | | |
| S9 | Fifth lens | 12.75 | 0.301 | 1.567 | 38.0 | -34.57 |
| S10 | | 7.68 | 0.366 | | | |
| S11 | Sixth lens | 2.99 | 0.489 | 1.544 | 56.1 | 5.99 |
| S12 | | 32.03 | 0.634 | | | |
| S13 | Seventh lens | -63.98 | 0.490 | 1.535 | 56.1 | -4.05 |
| S14 | | 2.26 | 0.210 | | | |
| S15 | Filter | Infinity | 0.110 | 1.518 | 64.2 | |
| S16 | | Infinity | 0.750 | | | |
| S17 | Imaging plane | Infinity | | | | |

A total focal length f of the optical imaging system 100 in the first example embodiment is 5.4292 mm, f345 is -38.2 mm, IMG HT is 5.107 mm, SWG31_0.2 is - 0.5°, SWG31_0.5 is -2.45°, SWG41_0.3 is 0.57°, SWG42_0.2 is 0.5°, and SWG42 is -6.2°.

In the first example embodiment, the first lens 110 may have positive refractive power, the first surface of the first lens 110 may be convex, and the second surface of the first lens 110 may be concave.

The second lens 120 may have negative refractive power, the first surface of the second lens 120 may be convex, and the second surface of the second lens 120 may be concave.

The third lens 130 may have positive refractive power, the first surface of the third lens 130 may be concave, and the second surface of the third lens 130 may be convex.

The fourth lens 140 may have negative refractive power, the first surface of the fourth lens 140 may be convex in the paraxial region, and the second surface of the fourth lens 140 may be concave in the paraxial region.

Also, at least one inflection point may be formed on at least one of the first and second surfaces of the fourth lens 140. For example, the first surface of the fourth lens 140 may be convex in the paraxial region and may be concave in a portion other than the paraxial region. Also, the second surface of the fourth lens 140 may be concave in the paraxial region and may be convex in a portion other than the paraxial region.

The fifth lens 150 may have negative refractive power, the first surface of the fifth lens 150 may be convex, and the second surface of the fifth lens 150 may be concave.

The sixth lens 160 may have positive refractive power, the first surface of the sixth lens 160 may be convex in the paraxial region, and the second surface of the sixth lens 160 may be concave in the paraxial region.

Also, at least one inflection point may be formed on at least one of the first and second surfaces of the sixth lens 160. For example, the first surface of the sixth lens 160 may be convex in the paraxial region and may be concave in a portion other than the paraxial region. Also, the second surface of the sixth lens 160 may be concave in the paraxial region and may be convex in a portion other than the paraxial region.

The seventh lens 170 may have negative refractive power, and the first and second surfaces of the seventh lens 170 may be concave in the paraxial region.

Also, at least one inflection point may be formed on at least one of the first and second surfaces of the seventh lens 170. For example, the first surface of the seventh lens 170 may be concave in the paraxial region and may be convex in a portion other than the paraxial region. Also, the second surface of the seventh lens 170 may be concave in the paraxial region and may be convex in a portion other than the paraxial region.

Each surface of the first lens 110 to the seventh lens 170 may have an aspherical coefficient as listed in Table 2. For example, both the object-side surface and the image-side surface of the first lens 110 to the seventh lens 170 may be aspherical.

Table 2

| | | | | | | | |
|---|---|---|---|---|---|---|---|
| | S1 | S2 | S3 | S4 | S5 | S6 | S7 |
| Conic constant (K) | -0.880 | 15.877 | 98.786 | 8.133 | -9.877 | 99.000 | -31.975 |
| 4th coefficient (A) | 8.021 E-02 | -5.209E-02 | 1.569E-02 | 3.519E-02 | -6.073E-02 | -1.150E-01 | -2.382E-01 |
| 6th coefficient (B) | 1.391 E-03 | 4.260E-03 | 1.481 E-02 | 7.803E-03 | -2.478E-03 | -5.451 E-03 | -1.035E-02 |
| 8th coefficient (C) | -2.172E-03 | -1.914E-03 | -1.095E-04 | 1.032E-03 | 3.338E-04 | -1.447E-03 | -2.000E-03 |
| 10th coefficient (D) | -9.494E-04 | -6.068E-05 | 8.332E-04 | 7.570E-04 | 4.990E-04 | 1.038E-03 | 9.825E-04 |
| 12th coefficient (E) | -3.493E-04 | 1.670E-05 | 1.105E-04 | 3.165E-04 | 2.945E-04 | 1.741 E-04 | -5.855E-04 |
| 14th coefficient (F) | -9.608E-05 | -4.844E-05 | 9.065E-07 | 1.110E-04 | 8.712E-05 | 1.060E-04 | -6.853E-04 |
| 16th coefficient (G) | -2.194E-05 | 3.888E-05 | 2.991 E-05 | 8.185E-05 | 4.771 E-05 | 3.706E-06 | -4.832E-04 |
| 18th coefficient (H) | -5.205E-06 | -1.372E-05 | -1.758E-05 | 1.819E-05 | 2.981 E-06 | 6.400E-05 | -2.053E-04 |
| 20th coefficient (J) | 6.686E-06 | 1.188E-05 | 4.677E-06 | 1.962E-05 | 1.128E-05 | 4.913E-05 | -3.086E-05 |
| 22nd coefficient (L) | -8.872E-06 | -8.599E-06 | -6.296E-06 | -1.579E-06 | -6.888E-06 | 4.541 E-05 | 1.476E-06 |
| 24th coefficient (M) | 1.448E-07 | 3.405E-06 | 4.032E-06 | 4.097E-06 | 6.361 E-06 | 2.575E-05 | 2.567E-05 |
| 26th coefficient (N) | -1.838E-06 | -2.179E-06 | 3.321 E-07 | -2.261 E-06 | -3.065E-06 | 1.539E-05 | 7.681 E-06 |
| 28th coefficient (O) | 5.991 E-06 | 5.769E-06 | 5.170E-06 | 2.336E-06 | 5.589E-06 | -3.431 E-06 | 1.219E-05 |
| 30th coefficient (P) | -1.957E-06 | -2.327E-06 | -9.885E-07 | -3.358E-06 | -2.013E-06 | -5.129E-06 | 6.068E-06 |
| Conic constant (K) | 5.920 | -44.398 | 3.642 | -0.730 | 48.617 | 99.000 | -1.197 |
| 4th coefficient (A) | -2.809E-01 | -6.655E-01 | -1.073E+00 | -2.559E+00 | -8.367E-01 | -9.605E-01 | -5.119E+00 |
| 6th coefficient (B) | 1.956E-02 | 2.470E-02 | 2.451 E-01 | 5.351 E-01 | -1.173E-01 | 5.683E-01 | 1.309E+00 |
| 8th coefficient (C) | 1.358E-02 | 8.703E-03 | -5.588E-02 | -2.258E-02 | 1.261 E-01 | -2.796E-01 | -3.633E-01 |
| 10th coefficient (D) | 6.678E-03 | 2.351 E-02 | 5.649E-03 | -4.742E-02 | -4.276E-02 | 1.430E-01 | 1.521 E-01 |
| 12th coefficient (E) | -3.574E-04 | -2.647E-04 | -8.593E-03 | 2.033E-02 | 3.177E-02 | -7.829E-02 | -8.366E-02 |
| 14th coefficient (F) | -9.705E-04 | -3.406E-03 | 2.746E-03 | -1.969E-03 | -8.478E-04 | 4.648E-02 | 3.933E-02 |
| 16th coefficient (G) | -6.827E-04 | -2.829E-03 | -2.153E-04 | -6.225E-03 | -4.027E-03 | -2.622E-02 | -1.559E-02 |
| 18th coefficient (H) | -1.117E-04 | -2.910E-04 | -1.349E-04 | 4.671 E-03 | -4.747E-03 | 8.157E-03 | 9.266E-03 |
| 20th coefficient (J) | 3.083E-05 | 3.791 E-04 | -5.046E-04 | 6.717E-04 | -7.511 E-04 | -4.895E-04 | -8.014E-03 |
| 22nd coefficient (L) | 5.088E-05 | 2.666E-04 | 1.432E-04 | -1.630E-03 | 5.815E-04 | -1.445E-03 | 1.204E-03 |
| 24th coefficient (M) | 8.071 E-06 | 3.278E-06 | 4.600E-05 | 4.453E-04 | 6.141E-04 | 4.633E-04 | -5.668E-04 |
| 26th coefficient (N) | -3.088E-06 | -8.293E-05 | -4.722E-05 | 4.470E-04 | 3.324E-04 | 6.225E-04 | 1.110E-03 |
| 28th coefficient (O) | -1.047E-05 | -5.973E-05 | -9.469E-05 | -1.967E-04 | 3.559E-04 | -4.955E-04 | -6.732E-04 |
| 30th coefficient (P) | -2.220E-06 | -1.924E-05 | 3.490E-06 | -5.013E-05 | 1.400E-04 | 1.754E-04 | 3.416E-04 |

The optical imaging system configured as above may have aberration properties as in FIG. 2.

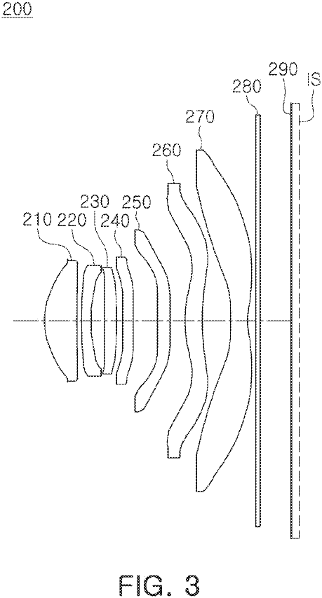

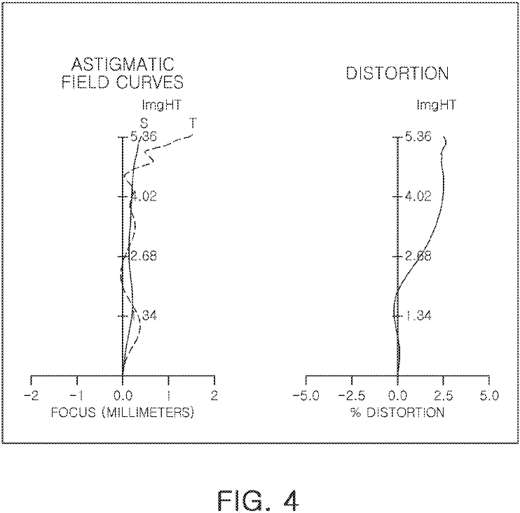

An optical imaging system according to a second example embodiment will be described with reference to FIGS. 3 and 4.

The optical imaging system 200 in the second example embodiment may include an optical system including a first lens 210, a second lens 220, a third lens 230, a fourth lens 240, a fifth lens 250, a sixth lens 260, and a seventh lens 270, and may further include a filter 280 and an image sensor IS.

The optical imaging system 200 in the second example embodiment may form a focus on an imaging plane 290. The imaging plane 290 may refer to a surface on which a focus is formed by the optical imaging system. For example, the imaging plane 290 may refer to one surface of the image sensor IS on which light is received.

The lens properties (a radius of curvature, a thickness of the lens or a distance between the lenses, a refractive index, an Abbe number, and a focal length) of each lens are listed in Table 3.

Table 3

| | | | | | | |
|---|---|---|---|---|---|---|
| Surface No. | Note | Radius of curvature | Thickness or distance | Refractive index | Abbe number | Focal length |
| S1 | First lens | 1.97 | 0.781 | 1.544 | 56.1 | 4.54 |
| S2 | | 8.32 | 0.131 | | | |
| S3 | Second lens | 11.84 | 0.230 | 1.661 | 20.4 | -11.67 |
| S4 | | 4.67 | 0.324 | | | |
| S5 | Third lens | 32.80 | 0.282 | 1.567 | 38.0 | 72.60 |
| S6 | | 156.96 | 0.153 | | | |
| S7 | Fourth lens | 10.96 | 0.250 | 1.661 | 20.4 | -124.044 |
| S8 | | 9.59 | 0.598 | | | |
| S9 | Fifth lens | 12.20 | 0.300 | 1.567 | 38.0 | -38.299 |
| S10 | | 7.76 | 0.364 | | | |
| S11 | Sixth lens | 2.57 | 0.440 | 1.544 | 56.1 | 5.587 |
| S12 | | 15.24 | 0.673 | | | |
| S13 | Seventh lens | -16.36 | 0.420 | 1.535 | 56.1 | -3.929 |
| S14 | | 2.44 | 0.206 | | | |
| S15 | Filter | Infinity | 0.110 | 1.518 | 64.2 | |
| S16 | | Infinity | 0.728 | | | |
| S17 | Imaging plane | Infinity | | | | |

A total focal length f of the optical imaging system 200 in the second example embodiment is 5.4006 mm, f345 is -51.398 mm, IMG HT is 5.107 mm, SWG31_0.2 is 0.48°, SWG31_0.5 is 0.29°, SWG41_0.3 is 0.7°, SWG42_0.2 is 0.52°, and SWG42 is -9.2°.

In the second example embodiment, the first lens 210 may have positive refractive power, the first surface of the first lens 210 may be convex, and the second surface of the first lens 210 may be concave.

The second lens 220 may have negative refractive power, the first surface of the second lens 220 may be convex, and the second surface of the second lens 220 may be concave.

The third lens 230 may have positive refractive power, the first surface of the third lens 230 may be convex, and the second surface of the third lens 230 may be concave.

The fourth lens 240 may have negative refractive power, the first surface of the fourth lens 240 may be convex in the paraxial region, and the second surface of the fourth lens 240 may be concave in the paraxial region.

The fifth lens 250 may have negative refractive power, the first surface of the fifth lens 250 may be convex, and the second surface of the fifth lens 250 may be concave.

Also, at least one inflection point may be formed on at least one of the first and second surfaces of the fifth lens 250. For example, the first surface of the fifth lens 250 may be convex in the paraxial region and may be concave in a portion other than the paraxial region. Also, the second surface of the fifth lens 250 may be concave in the paraxial region and may be convex in a portion other than the paraxial region.

The sixth lens 260 may have positive refractive power, the first surface of the sixth lens 260 may be convex in the paraxial region, and the second surface of the sixth lens 260 may be concave in the paraxial region.

Also, at least one inflection point may be formed on at least one of the first and second surfaces of the sixth lens 260. For example, the first surface of the sixth lens 260 may be convex in the paraxial region and may be concave in a portion other than the paraxial region. Also, the second surface of the sixth lens 260 may be concave in the paraxial region and may be convex in a portion other than the paraxial region.

The seventh lens 270 may have negative refractive power, and the first and second surfaces of the seventh lens 270 may be concave in the paraxial region.

Also, at least one inflection point may be formed on at least one of the first and second surfaces of the seventh lens 270. For example, the first surface of the seventh lens 270 may be concave in the paraxial region and may be convex in a portion other than the paraxial region. Also, the second surface of the seventh lens 270 may be concave in the paraxial region and may be convex in a portion other than the paraxial region.

Each surface of the first lens 210 to the seventh lens 270 may have an aspherical coefficient as listed in Table 4. For example, both the object-side surface and the image-side surface of the first lens 210 to the seventh lens 270 may be aspherical.

Table 4

| | | | | | | | |
|---|---|---|---|---|---|---|---|
| | S1 | S2 | S3 | S4 | S5 | S6 | S7 |
| Conic constant (K) | -1.197 | 5.201 | 35.181 | 6.289 | 98.969 | -90.000 | -45.063 |
| 4th coefficient (A) | 6.813E-02 | -7.642E-02 | -3.924E-03 | 2.832E-02 | -3.446E-02 | -9.354E-02 | -2.304E-01 |
| 6th coefficient (B) | -1.204E-02 | -1.637E-03 | 2.743E-02 | 1.675E-02 | -2.852E-03 | 1.460E-03 | 1.578E-02 |
| 8th coefficient (C) | -5.658E-03 | -1.531E-03 | -2.368E-03 | 5.644E-04 | 1.268E-03 | -4.407E-04 | 3.943E-03 |
| 10th coefficient (D) | -1.554E-03 | -4.618E-04 | 2.174E-03 | 1.539E-03 | 4.666E-06 | 1.231 E-03 | 1.722E-04 |
| 12th coefficient (E) | -2.094E-04 | 3.712E-04 | -4.881 E-04 | 1.761 E-04 | 4.698E-04 | -4.637E-04 | -2.616E-03 |
| 14th coefficient (F) | 4.871 E-06 | -2.896E-04 | 2.709E-04 | 2.032E-04 | -1.594E-04 | -2.272E-04 | -1.924E-03 |
| 16th coefficient (G) | 5.067E-05 | 1.840E-04 | -1.792E-04 | -5.757E-06 | 1.276E-04 | -1.876E-04 | -6.399E-04 |
| 18th coefficient (H) | -8.245E-06 | -1.272E-04 | 1.052E-04 | 4.392E-05 | -9.328E-05 | 3.097E-05 | -1.531E-04 |
| 20th coefficient (J) | 1.392E-05 | 9.536E-05 | -8.553E-05 | -1.900E-05 | 6.340E-05 | 2.531 E-05 | 5.602E-05 |
| 22nd coefficient (L) | -1.849E-05 | -6.797E-05 | 5.236E-05 | 1.519E-05 | -3.855E-05 | 4.482E-05 | -3.978E-05 |
| 24th coefficient (M) | 6.093E-06 | 5.087E-05 | -4.143E-05 | -9.999E-06 | 2.986E-05 | 3.273E-06 | -1.210E-05 |
| 26th coefficient (N) | -9.061 E-06 | -3.994E-05 | 2.794E-05 | 2.344E-06 | -2.077E-05 | 5.668E-06 | -3.094E-05 |
| 28th coefficient (O) | 1.170E-05 | 3.759E-05 | -2.345E-05 | -9.382E-06 | 1.122E-05 | -3.701 E-06 | 7.743E-06 |
| 30th coefficient (P) | -3.718E-06 | -1.905E-05 | 1.768E-05 | -4.573E-06 | -2.837E-06 | 3.535E-06 | -9.428E-06 |
| | S8 | S9 | S10 | S11 | S12 | S13 | S14 |
| Conic constant (K) | 7.390 | -98.999 | 0.237 | -0.903 | 15.025 | 6.397 | -1.017 |
| 4th coefficient (A) | -3.232E-01 | -7.802E-01 | -1.108E+00 | -2.772E+00 | -1.089E+00 | -6.842E-01 | -5.123E+00 |
| 6th coefficient (B) | 4.384E-02 | 8.936E-02 | 2.590E-01 | 5.498E-01 | -3.362E-02 | 5.285E-01 | 1.160E+00 |
| 8th coefficient (C) | 1.210E-02 | 4.013E-02 | -4.630E-02 | -1.018E-02 | 1.554E-01 | -2.548E-01 | -3.770E-01 |
| 10th coefficient (D) | 1.668E-03 | 1.216E-02 | 4.030E-03 | -3.576E-02 | -3.430E-02 | 1.603E-01 | 1.918E-01 |
| 12th coefficient (E) | -4.214E-03 | -1.400E-02 | -4.782E-03 | 2.095E-02 | 2.682E-02 | -1.004E-01 | -7.968E-02 |
| 14th coefficient (F) | -1.767E-03 | -5.424E-03 | 3.490E-03 | -8.976E-03 | -1.407E-02 | 5.516E-02 | 4.249E-02 |
| 16th coefficient (G) | -1.437E-04 | 1.810E-03 | 3.835E-04 | -3.684E-03 | -2.278E-03 | -2.741 E-02 | -2.201 E-02 |
| 18th coefficient (H) | 5.947E-04 | 2.073E-03 | -7.989E-04 | 3.369E-03 | -3.853E-03 | 8.699E-03 | 7.271 E-03 |
| 20th coefficient (J) | 2.956E-04 | 9.825E-05 | -1.686E-05 | 1.472E-03 | 3.015E-03 | -3.773E-04 | -5.236E-03 |
| 22nd coefficient (L) | 6.615E-05 | -9.311 E-04 | 2.463E-04 | -2.008E-03 | -3.676E-04 | -3.148E-03 | 3.575E-04 |
| 24th coefficient (M) | -9.088E-05 | -4.787E-04 | 9.204E-05 | 5.694E-04 | 6.783E-04 | 2.659E-03 | -8.221 E-04 |
| 26th coefficient (N) | -4.567E-05 | -1.381 E-04 | -2.166E-04 | -1.360E-04 | -6.715E-04 | -1.203E-03 | 3.709E-04 |
| 28th coefficient (O) | -3.109E-05 | 6.083E-05 | -6.061 E-05 | 2.270E-04 | 3.804E-04 | -1.013E-04 | -2.306E-04 |
| 30th coefficient (P) | 7.868E-06 | 1.477E-05 | 2.139E-05 | -9.389E-05 | -1.042E-04 | 1.477E-04 | 2.533E-04 |

The optical imaging system configured as above may have aberration properties as in FIG. 4.

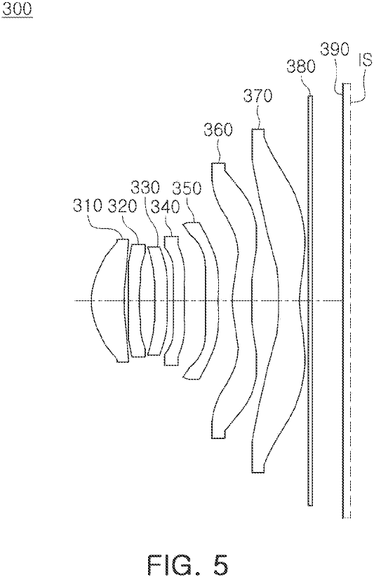

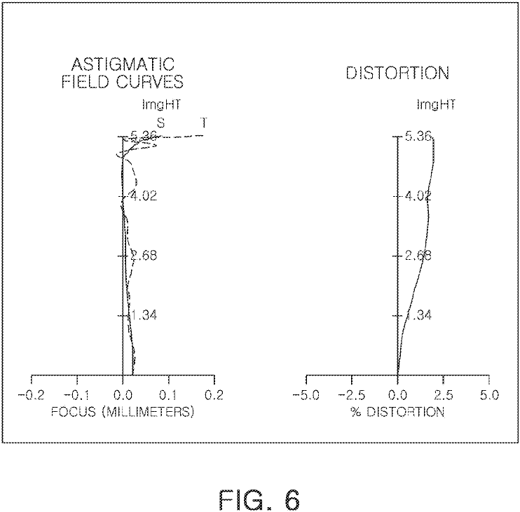

An optical imaging system according to a third example embodiment will be described with reference to FIGS. 5 and 6.

The optical imaging system 300 in the third example embodiment may include an optical system including a first lens 310, a second lens 320, a third lens 330, a fourth lens 340, a fifth lens 350, a sixth lens 360, and a seventh lens 370, and may further include a filter 380 and an image sensor IS.

The optical imaging system 300 in the third example embodiment may form a focus on an imaging plane 390. The imaging plane 390 may refer to a surface on which a focus is formed by the optical imaging system. For example, the imaging plane 390 may refer to one surface of the image sensor IS on which light is received.

The lens properties (a radius of curvature, a thickness of the lens or a distance between the lenses, a refractive index, an Abbe number, and a focal length) of each lens are listed in Table 5.

Table 5

| Surface No. | Note | Radius of curvature | Thickness or distance | Refractive index | Abbe number | Focal length |
|---|---|---|---|---|---|---|
| S1 | First lens | 1.97 | 0.781 | 1.544 | 56.1 | 4.54 |
| S2 | | 8.32 | 0.131 | | | |
| S3 | Second lens | 11.84 | 0.230 | 1.661 | 20.4 | -11.67 |
| S4 | | 4.67 | 0.324 | | | |
| S5 | Third lens | 32.80 | 0.282 | 1.567 | 38.0 | 72.60 |
| S6 | | 156.96 | 0.153 | | | |
| S7 | Fourth lens | 10.96 | 0.250 | 1.661 | 20.4 | -124.044 |
| S8 | | 9.59 | 0.598 | | | |

| | | | | | | |
|---|---|---|---|---|---|---|
| S9 | Fifth lens | 12.20 | 0.300 | 1.567 | 38.0 | -38.299 |
| S10 | | 7.76 | 0.364 | | | |
| S11 | Sixth lens | 2.57 | 0.440 | 1.544 | 56.1 | 5.587 |
| S12 | | 15.24 | 0.673 | | | |
| S13 | Seventh lens | -16.36 | 0.420 | 1.535 | 56.1 | -3.929 |
| S14 | | 2.44 | 0.206 | | | |
| S15 | Filter | Infinity | 0.110 | 1.518 | 64.2 | |
| S16 | | Infinity | 0.728 | | | |
| S17 | Imaging plane | Infinity | | | | |

A total focal length f of the optical imaging system 300 in the third example embodiment is 5.4291 mm, f345 is -31.316 mm, IMG HT is 5.107 mm, SWG31_0.2 is -0.6°, SWG31_0.5 is -2.9°, SWG41_0.3 is 0.55°, SWG42_0.2 is 0.47°, and SWG42 is -2.9°.

In the third example embodiment, the first lens 310 may have positive refractive power, the first surface of the first lens 310 may be convex, and the second surface of the first lens 310 may be concave.

The second lens 320 may have negative refractive power, the first surface of the second lens 320 may be convex, and the second surface of the second lens 320 may be concave.

The third lens 330 may have positive refractive power, the first surface of the third lens 330 may be convex, and the second surface of the third lens 330 may be concave.

The fourth lens 340 may have negative refractive power, the first surface of the fourth lens 340 may be convex, and the second surface of the fourth lens 340 may be concave.

The fifth lens 350 may have negative refractive power, the first surface of the fifth lens 350 may be convex in the paraxial region, and the second surface of the fifth lens 350 may be concave in the paraxial region.

Also, at least one inflection point may be formed on at least one of the first and second surfaces of the fifth lens 350. For example, the first surface of the fifth lens 350 may be convex in the paraxial region and may be concave in a portion other than the paraxial region. Also, the second surface of the fifth lens 350 may be concave in the paraxial region and may be convex in a portion other than the paraxial region.

The sixth lens 360 may have positive refractive power, the first surface of the sixth lens 360 may be convex in the paraxial region, and the second surface of the sixth lens 360 may be concave in the paraxial region.

Also, at least one inflection point may be formed on at least one of the first and second surfaces of the sixth lens 360. For example, the first surface of the sixth lens 360 may be convex in the paraxial region and may be concave in a portion other than the paraxial region. Also, the second surface of the sixth lens 360 may be concave in the paraxial region and may be convex in a portion other than the paraxial region.

The seventh lens 370 may have negative refractive power, and the first and second surfaces of the seventh lens 370 may be concave in the paraxial region.

Also, at least one inflection point may be formed on at least one of the first and second surfaces of the seventh lens 370. For example, the first surface of the seventh lens 370 may be concave in the paraxial region and may be convex in a portion other than the paraxial region. Also, the second surface of the seventh lens 370 may be concave in the paraxial region and may be convex in a portion other than the paraxial region.

Each surface of the first lens 310 to the seventh lens 370 may have an aspherical coefficient as listed in Table 6. For example, both the object-side surface and the image-side surface of the first lens 310 to the seventh lens 370 may be aspherical.

Table 6

| | | | | | | | |
|---|---|---|---|---|---|---|---|
| | S1 | S2 | S3 | S4 | S5 | S6 | S7 |
| Conic constant (K) | -0.877 | 16.283 | 99.000 | 6.441 | 76.286 | 82.700 | -68.372 |
| 4th coefficient (A) | 7.898E-02 | -5.068E-02 | 1.970E-02 | 3.412E-02 | -6.642E-02 | -1.081E-01 | -2.418E-01 |
| 6th coefficient (B) | 2.458E-03 | 4.844E-03 | 1.532E-02 | 8.051 E-03 | -2.192E-03 | -4.180E-03 | -9.992E-03 |
| 8th coefficient (C) | -2.039E-03 | -1.719E-03 | 3.344E-04 | 1.166E-03 | 1.129E-03 | -1.757E-04 | -2.838E-03 |
| 10th coefficient (D) | -9.118E-04 | 2.064E-05 | 1.154E-03 | 1.146E-03 | 9.578E-04 | 1.878E-03 | 9.167E-04 |
| 12th coefficient (E) | -4.334E-04 | 1.116E-06 | 2.056E-04 | 4.135E-04 | 4.580E-04 | 6.542E-04 | -3.277E-04 |
| 14th coefficient (F) | -1.093E-04 | 1.839E-06 | 7.337E-05 | 2.262E-04 | 1.524E-04 | 3.759E-04 | -4.334E-04 |
| 16th coefficient (G) | -4.831 E-05 | 9.822E-06 | 1.767E-05 | 9.062E-05 | 6.091 E-05 | 1.566E-04 | -3.050E-04 |
| 18th coefficient (H) | 2.304E-06 | -7.869E-06 | -1.261 E-05 | 4.599E-05 | 1.143E-05 | 1.255E-04 | -1.294E-04 |
| 20th coefficient (J) | 2.542E-06 | -3.835E-06 | -1.010E-05 | 1.121E-05 | 6.528E-06 | 7.605E-05 | -3.106E-06 |
| 22nd coefficient (L) | -4.252E-07 | -9.406E-06 | -1.192E-05 | 7.462E-06 | -3.145E-07 | 5.143E-05 | 5.641 E-06 |
| 24th coefficient (M) | -4.652E-06 | -6.270E-06 | -4.818E-06 | -7.745E-07 | 4.447E-06 | 3.136E-05 | 2.169E-05 |
| 26th coefficient (N) | -4.383E-07 | -3.676E-06 | -1.766E-06 | 3.601 E-06 | -4.155E-07 | 8.319E-06 | -1.483E-06 |
| 28th coefficient (O) | 4.076E-07 | 1.946E-06 | 4.412E-06 | -3.226E-06 | 1.622E-06 | -6.895E-06 | 5.371 E-06 |
| 30th coefficient (P) | 1.184E-06 | 3.143E-06 | 3.705E-06 | 1.204E-06 | -1.997E-06 | -1.440E-05 | 5.612E-07 |
| | S8 | S9 | S10 | S11 | S12 | S13 | S14 |
| Conic constant (K) | -10.383 | -33.858 | 1.374 | -0.768 | 15.615 | 99.000 | -1.222 |
| 4th coefficient (A) | -2.900E-01 | -6.783E-01 | -1.097E+00 | -2.663E+00 | -9.524E-01 | -9.944E-01 | -4.993E+00 |
| 6th coefficient (B) | 2.352E-02 | 2.007E-02 | 2.422E-01 | 5.658E-01 | -1.214E-01 | 5.061 E-01 | 1.237E+00 |
| 8th coefficient (C) | 1.325E-02 | 1.338E-02 | -4.804E-02 | -3.496E-02 | 1.319E-01 | -2.405E-01 | -3.428E-01 |
| 10th coefficient (D) | 6.093E-03 | 2.367E-02 | 5.640E-03 | -4.737E-02 | -4.311 E-02 | 1.261 E-01 | 1.500E-01 |
| 12th coefficient (E) | -3.561 E-04 | -2.069E-03 | -1.097E-02 | 2.150E-02 | 3.320E-02 | -7.358 E-02 | -8.522E-02 |
| 14th coefficient (F) | -9.645E-04 | -3.493E-03 | 3.907E-03 | -2.219E-03 | -8.390E-03 | 4.798E-02 | 4.163E-02 |
| 16th coefficient (G) | -5.779E-04 | -2.176E-03 | 7.819E-04 | -2.866E-03 | -1.733E-03 | -2.450E-02 | -1.279E-02 |
| 18th coefficient (H) | -1.199E-04 | 3.396E-04 | -8.394E-05 | 4.010E-03 | -1.497E-03 | 6.957E-03 | 9.504E-03 |
| 20th coefficient (J) | 4.162E-05 | 4.325E-04 | -8.538E-04 | -1.571 E-03 | 3.067E-04 | -1.260E-03 | -8.537E-03 |
| 22nd coefficient (L) | 2.943E-05 | 1.207E-04 | 1.498E-04 | -6.733E-04 | 1.595E-03 | -3.525E-04 | 1.993E-03 |
| 24th coefficient (M) | 1.224E-05 | -1.284E-04 | 1.252E-04 | 6.277E-04 | -1.795E-04 | -7.134E-04 | -1.595E-03 |
| 26th coefficient (N) | -7.094E-06 | -4.587E-05 | 2.493E-06 | 1.695E-04 | 3.953E-04 | 1.517E-03 | 9.000E-04 |
| 28th coefficient (O) | 2.410E-07 | -1.001 E-06 | -1.446E-04 | -4.652E-04 | 7.678E-05 | -6.972E-04 | -6.082E-04 |
| 30th coefficient (P) | -1.463E-06 | 3.352E-05 | -9.145E-06 | 1.126E-05 | 1.554E-04 | 1.079E-04 | 6.516E-04 |

The optical imaging system configured as above may have aberration properties as in FIG. 6.

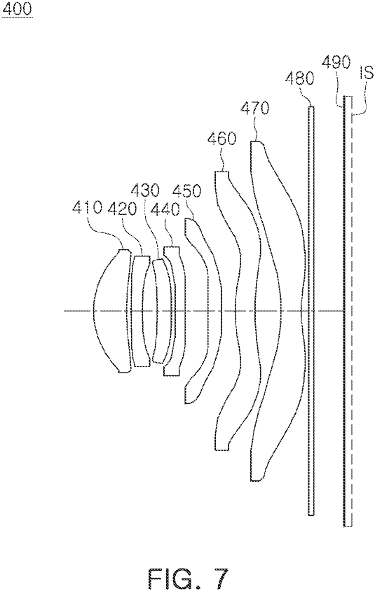

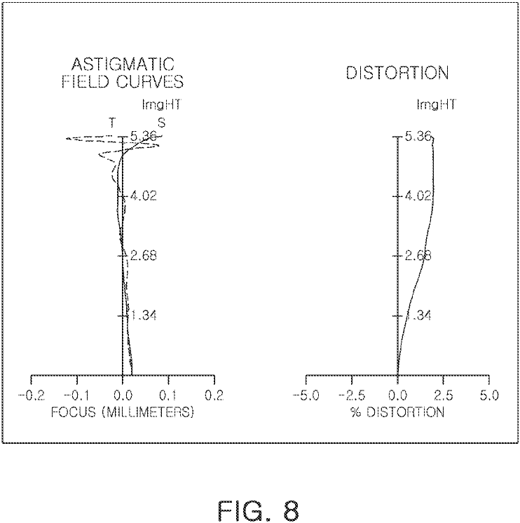

An optical imaging system according to a fourth example embodiment will be described with reference to FIGS. 7 and 8.

The optical imaging system 400 in the fourth example embodiment may include an optical system including a first lens 410, a second lens 420, a third lens 430, a fourth lens 440, a fifth lens 450, a sixth lens 460, and a seventh lens 470, and may further include a filter 480 and an image sensor IS.

The optical imaging system 400 in the fourth example embodiment may form a focus on an imaging plane 490. The imaging plane 490 may refer to a surface on which a focus is formed by the optical imaging system. For example, the imaging plane 490 may refer to one surface of the image sensor IS on which light is received.

The lens properties (a radius of curvature, a thickness of the lens or a distance between the lenses, a refractive index, an Abbe number, and a focal length) of each lens are listed in Table 7.

Table 7

| | | | | | | |
|---|---|---|---|---|---|---|
| Surface No. | Note | Radius of curvature | Thickness or distance | Refractive index | Abbe number | Focal length |
| S1 | First lens | 1.99 | 0.826 | 1.544 | 56.1 | 4.5489 |
| S2 | | 8.50 | 0.080 | | | |
| S3 | Second lens | 16.56 | 0.274 | 1.671 | 19.4 | -12.6 |
| S4 | | 5.60 | 0.358 | | | |
| S5 | Third lens | -27.66 | 0.341 | 1.567 | 38.0 | 46.878 |
| S6 | | -13.66 | 0.102 | | | |
| S7 | Fourth lens | 21.24 | 0.250 | 1.671 | 19.4 | -118.937 |
| S8 | | 16.73 | 0.559 | | | |
| S9 | Fifth lens | 14.18 | 0.300 | 1.567 | 38.0 | -28.748 |
| S10 | | 7.55 | 0.343 | | | |
| S11 | Sixth lens | 2.81 | 0.478 | 1.544 | 56.1 | 6.1037 |
| S12 | | 16.87 | 0.628 | | | |
| S13 | Seventh lens | -75.54 | 0.490 | 1.535 | 56.1 | -4.1 |
| S14 | | 2.27 | 0.210 | | | |
| S15 | Filter | Infinity | 0.110 | 1.518 | 64.2 | |
| S16 | | Infinity | 0.740 | | | |
| S17 | Imaging plane | Infinity | | | | |

A total focal length f of the imaging optical system 400 in the fourth example embodiment is 5.4292 mm, f345 is -47.745 mm, IMG HT is 5.107 mm, SWG31_0.2 is -0.55°, SWG31_0.5 is -2.46°, SWG41_0.3 is 0.3°, SWG42_0.2 is 0.07°, and SWG42 is -3°.

In the fourth example embodiment, the first lens 410 may have positive refractive power, the first surface of the first lens 410 may be convex, and the second surface of the first lens 410 may be concave.

The second lens 420 may have negative refractive power, the first surface of the second lens 420 may be convex, and the second surface of the second lens 420 may be concave.

The third lens 430 may have positive refractive power, the first surface of the third lens 430 may be concave, and the second surface of the third lens 430 may be convex.

The fourth lens 440 may have negative refractive power, the first surface of the fourth lens 440 may be convex in the paraxial region, and the second surface of the fourth lens 440 may be concave in the paraxial region.

Also, at least one inflection point may be formed on at least one of the first and second surfaces of the fourth lens 440. For example, the first surface of the fourth lens 440 may be convex in the paraxial region and may be concave in a portion other than the paraxial region. Also, the second surface of the fourth lens 440 may be concave in the paraxial region and may be convex in a portion other than the paraxial region.

The fifth lens 450 may have negative refractive power, the first surface of the fifth lens 450 may be convex, and the second surface of the fifth lens 450 may be concave.

The sixth lens 460 may have positive refractive power, the first surface of the sixth lens 460 may be convex in the paraxial region, and the second surface of the sixth lens 460 may be concave in the paraxial region.

Also, at least one inflection point may be formed on at least one of the first and second surfaces of the sixth lens 460. For example, the first surface of the sixth lens 460 may be convex in the paraxial region and may be concave in a portion other than the paraxial region. Also, the second surface of the sixth lens 460 may be concave in the paraxial region and may be convex in a portion other than the paraxial region.

The seventh lens 470 may have negative refractive power, and the first and second surfaces of the seventh lens 470 may be concave in the paraxial region.

Also, at least one inflection point may be formed on at least one of the first and second surfaces of the seventh lens 470. For example, the first surface of the seventh lens 470 may be concave in the paraxial region and may be convex in a portion other than the paraxial region. Also, the second surface of the seventh lens 470 may be concave in the paraxial region and may be convex in a portion other than the paraxial region.

Each surface of the first lens 410 to the seventh lens 470 may have an aspherical coefficient as listed in Table 8. For example, both the object-side surface and the image-side surface of the first lens 410 to the seventh lens 470 may be aspherical.

Table 8

| | S1 | S2 | S3 | S4 | S5 | S6 | S7 |
|---|---|---|---|---|---|---|---|
| Conic constant (K) | -0.888 | 17.217 | 98.275 | 6.599 | 17.828 | 89.439 | -3.041 |
| 4th coefficient (A) | 7.819E-02 | -4.626E-02 | 1.001 E-02 | 3.106E-02 | -5.759E-02 | -1.092E-01 | -2.279E-01 |
| 6th coefficient (B) | 1.817E-03 | 3.928E-03 | 1.295E-02 | 7.903E-03 | -2.455E-03 | -2.540E-03 | -4.175E-03 |
| 8th coefficient (C) | -1.797E-03 | -1.854E-03 | -3.684E-04 | 9.920E-04 | 2.723E-04 | -1.146E-03 | -5.347E-04 |
| 10th coefficient (D) | -7.243E-04 | 1.453E-04 | 8.331 E-04 | 8.219E-04 | 3.666E-04 | 7.427E-04 | 8.608E-04 |
| 12th coefficient (E) | -2.885E-04 | -3.797E-05 | 3.610E-05 | 2.605E-04 | 2.118E-04 | -1.160E-04 | -9.635E-04 |
| 14th coefficient (F) | -6.301 E-05 | 1.545E-05 | 4.332E-05 | 1.355E-04 | 6.506E-05 | -5.168E-05 | -7.981 E-04 |
| 16th coefficient (G) | -1.769E-05 | 5.002E-06 | -3.356E-06 | 5.600E-05 | 2.293E-05 | -1.076E-04 | -5.758E-04 |
| 18th coefficient (H) | 4.574E-06 | 2.243E-06 | -7.952E-06 | 2.268E-05 | 4.654E-06 | 1.511 E-05 | -2.034E-04 |
| 20th coefficient (J) | -1.543E-06 | -1.402E-06 | -8.614E-06 | 4.584E-06 | 3.677E-06 | 1.718E-05 | -6.548E-05 |
| 22nd coefficient (L) | -3.302E-06 | -4.028E-06 | -3.917E-06 | -9.515E-07 | -2.117E-06 | 3.130E-05 | -4.894E-06 |
| 24th coefficient (M) | -2.249E-06 | -4.203E-07 | 3.343E-07 | -6.404E-07 | -1.525E-06 | 1.655E-05 | 2.478E-06 |
| 26th coefficient (N) | 8.223E-07 | -1.755E-06 | 1.293E-06 | 1.427E-06 | 3.659E-07 | 1.700E-05 | 1.027E-05 |
| 28th coefficient (O) | 1.392E-06 | 5.447E-07 | 3.900E-06 | -2.111 E-07 | 5.141E-07 | 9.035E-06 | 4.730E-06 |
| 30th coefficient (P) | 1.335E-07 | -5.769E-08 | 2.495E-06 | -4.337E-07 | 6.941 E-07 | 6.167E-06 | 9.974E-06 |
| | S8 | S9 | S10 | S11 | S12 | S13 | S14 |
| Conic constant (K) | 53.411 | -35.567 | 3.734 | -0.767 | 15.043 | 99.000 | -1.184 |
| 4th coefficient (A) | -2.704E-01 | -7.529E-01 | -1.183E+00 | -2.790E+00 | -1.050E+00 | -9.800E-01 | -5.040E+00 |
| 6th coefficient (B) | 2.380E-02 | 5.610E-02 | 2.826E-01 | 6.296E-01 | -9.806E-02 | 5.334E-01 | 1.275E+00 |
| 8th coefficient (C) | 1.468E-02 | 2.844E-02 | -7.003E-02 | -5.047E-02 | 1.608E-01 | -2.477E-01 | -3.522E-01 |
| 10th coefficient (D) | 4.974E-03 | 2.317E-02 | 3.378E-03 | -5.013E-02 | -4.237E-02 | 1.262E-01 | 1.424E-01 |
| 12th coefficient (E) | -1.244E-03 | -9.722E-03 | -9.873E-03 | 2.370E-02 | 3.239E-02 | -7.189E-02 | -7.696E-02 |
| 14th coefficient (F) | -1.304E-03 | -7.150E-03 | 4.710E-03 | -6.125E-03 | -1.390E-02 | 4.700E-02 | 4.176E-02 |
| 16th coefficient (G) | -6.409E-04 | -2.010E-03 | -1.109E-03 | -2.184E-03 | -6.183E-03 | -2.752E-02 | -1.513E-02 |
| 18th coefficient (H) | -2.522E-05 | 1.517E-03 | -9.993E-04 | 4.815E-03 | -4.567E-03 | 9.686E-03 | 8.321 E-03 |
| 20th coefficient (J) | 9.069E-05 | 7.454E-04 | -8.079E-04 | -1.463E-03 | 1.800E-03 | -4.202E-04 | -5.902E-03 |
| 22nd coefficient (L) | 6.470E-05 | -1.774E-04 | 2.542E-04 | -8.370E-04 | 2.454E-03 | -2.240E-03 | 1.543E-03 |
| 24th coefficient (M) | 8.495E-06 | -4.723E-04 | -1.607E-04 | 1.041 E-03 | 9.823E-04 | 8.570E-04 | -8.053E-04 |
| 26th coefficient (N) | -8.123E-06 | -2.291 E-04 | -1.945E-04 | 2.036E-05 | 5.779E-05 | 3.499E-04 | 7.840E-04 |
| 28th coefficient (O) | -1.125E-05 | -5.163E-05 | -8.885E-05 | -2.589E-04 | 5.301 E-05 | -4.124E-04 | -6.749E-04 |
| 30th coefficient (P) | 8.998E-07 | 3.622E-05 | 9.675E-05 | 1.018E-05 | -8.503E-05 | 7.981 E-05 | 2.089E-04 |

The optical imaging system configured as above may have aberration properties as in FIG. 8.

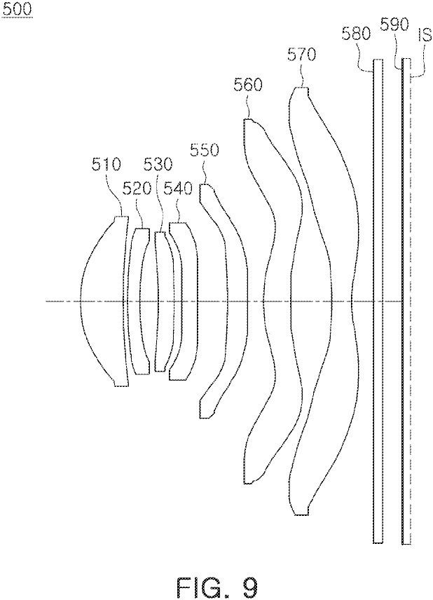

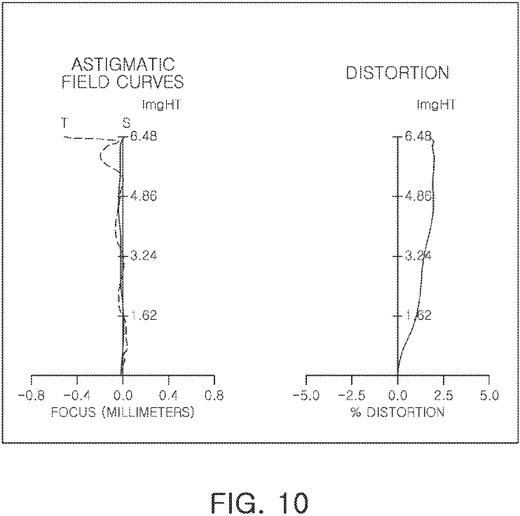

An optical imaging system according to a fifth example embodiment will be described with reference to FIGS. 9 and 10.

The optical imaging system 500 in the fifth example embodiment may include an optical system including a first lens 510, a second lens 520, a third lens 530, a fourth lens 540, a fifth lens 550, a sixth lens 560, and a seventh lens 570, and may further include a filter 580 and an image sensor IS.

The optical imaging system 500 in the fifth example embodiment may form a focus on an imaging plane 590. The imaging plane 590 may refer to a surface on which a focus is formed by the optical imaging system. For example, the imaging plane 590 may refer to one surface of the image sensor IS on which light is received.

The lens properties (a radius of curvature, a thickness of the lens or a distance between the lenses, a refractive index, an Abbe number, and a focal length) of each lens are listed in Table 9.

Table 9

| Surface | Note | Radius of | Thickness or | Refractive | Abbe | Focal |
|---|---|---|---|---|---|---|
| No. | | curvature | distance | index | number | length |
| S1 | First lens | 2.73 | 1.048 | 1.544 | 56.1 | 6.26 |
| S2 | | 11.78 | 0.116 | | | |
| S3 | Second lens | 12.55 | 0.280 | 1.671 | 19.4 | -17.15 |
| S4 | | 5.98 | 0.466 | | | |
| S5 | Third lens | -229.22 | 0.395 | 1.535 | 56.1 | 41.26 |
| S6 | | -20.20 | 0.172 | | | |
| S7 | Fourth lens | 34.97 | 0.388 | 1.671 | 19.4 | -57.88 |
| S8 | | 18.39 | 0.712 | | | |
| S9 | Fifth lens | 31.10 | 0.479 | 1.567 | 38.0 | -36.776 |
| S10 | | 12.45 | 0.380 | | | |
| S11 | Sixth lens | 2.90 | 0.670 | 1.544 | 56.1 | 6.208 |
| S12 | | 18.39 | 1.011 | | | |
| S13 | Seventh lens | -34.08 | 0.490 | 1.535 | 56.1 | -4.883 |
| S14 | | 2.85 | 0.520 | | | |
| S15 | Filter | Infinity | 0.210 | 1.518 | 64.2 | |
| S16 | | Infinity | 0.493 | | | |
| S17 | Imaging plane | Infinity | | | | |

A total focal length f of the imaging optical system 500 in the fifth example embodiment is 6.5 mm, f345 is -52.222 mm, IMG HT is 6 mm, SWG31_0.2 is -0.15°, SWG31_0.5 is -1.52°, SWG41_0.3 is 0.5°, SWG42_0.2 is -0.19°, and SWG42 is -8.2°.

In the fifth example embodiment, the first lens 510 may have positive refractive power, the first surface of the first lens 510 may be convex, and the second surface of the first lens 510 may be concave.

The second lens 520 may have negative refractive power, the first surface of the second lens 520 may be convex, and the second surface of the second lens 520 may be concave.

The third lens 530 may have positive refractive power, the first surface of the third lens 530 may be concave, and the second surface of the third lens 530 may be convex.

The fourth lens 540 may have negative refractive power, the first surface of the fourth lens 540 may be convex, and the second surface of the fourth lens 540 may be concave.

The fifth lens 550 may have negative refractive power, the first surface of the fifth lens 550 may be convex, and the second surface of the fifth lens 550 may be concave.

The sixth lens 560 may have positive refractive power, the first surface of the sixth lens 560 may be convex in the paraxial region, and the second surface of the sixth lens 560 may be concave in the paraxial region.

Also, at least one inflection point may be formed on at least one of the first and second surfaces of the sixth lens 560. For example, the first surface of the sixth lens 560 may be convex in the paraxial region and may be concave in a portion other than the paraxial region. Also, the second surface of the sixth lens 560 may be concave in the paraxial region and may be convex in a portion other than the paraxial region.

The seventh lens 570 may have negative refractive power, and the first and second surfaces of the seventh lens 570 may be concave in the paraxial region.

Also, at least one inflection point may be formed on at least one of the first and second surfaces of the seventh lens 570. For example, the first surface of the seventh lens 570 may be concave in the paraxial region and may be convex in a portion other than the paraxial region. Also, the second surface of the seventh lens 570 may be concave in the paraxial region and may be convex in a portion other than the paraxial region.

Each surface of the first lens 510 to the seventh lens 570 may have an aspherical coefficient as listed in Table 10. For example, both the object-side surface and the image-side surface of the first lens 510 to the seventh lens 570 may be aspherical.

Table 10

| | | | | | | | |
|---|---|---|---|---|---|---|---|
| | S1 | S2 | S3 | S4 | S5 | S6 | S7 |
| Conic constant (K) | -1.097 | 18.482 | 30.108 | 2.815 | -99.000 | 95.000 | -79.991 |
| 4th coefficient (A) | 1.222E-01 | -5.129E-02 | -3.872E-03 | 1.541 E-02 | -7.966E-02 | -1.308E-01 | -2.951 E-01 |
| 6th coefficient (B) | -5.844E-03 | 3.397E-03 | 1.848E-02 | 1.219E-02 | -4.133E-03 | -2.427E-03 | -6.200E-03 |
| 8th coefficient (C) | -5.370E-03 | -1.724E-03 | 1.734E-03 | 3.803E-03 | 1.258E-03 | -3.765E-04 | -2.047E-03 |
| 10th coefficient (D) | -2.104E-03 | -9.141 E-05 | 6.870E-04 | 1.789E-03 | 7.564E-04 | 7.911 E-04 | 1.111E-03 |
| 12th coefficient (E) | -5.553E-04 | 9.598E-06 | 3.786E-04 | 1.059E-03 | 2.485E-04 | 4.461 E-05 | 3.049E-04 |
| 14th coefficient (F) | -1.319E-04 | -5.241 E-05 | -1.117E-04 | 3.329E-04 | 1.221 E-04 | 1.834E-04 | 2.794E-04 |
| 16th coefficient (G) | -6.335E-06 | 1.523E-05 | 7.072E-05 | 2.505E-04 | 4.365E-05 | 4.013E-06 | 2.280E-05 |
| 18th coefficient (H) | -8.896E-07 | -4.700E-06 | -5.838E-05 | 4.964E-05 | 6.874E-06 | 1.231 E-05 | -1.129E-05 |
| 20th coefficient (J) | -2.116E-06 | 2.664E-07 | 1.626E-05 | 5.401 E-05 | 4.574E-06 | -9.731 E-06 | -1.051E-05 |
| 22nd coefficient (L) | -3.008E-06 | 1.576E-05 | -1.879E-05 | -6.233E-06 | 3.711 E-06 | 2.800E-06 | -8.661 E-06 |
| 24th coefficient (M) | 4.073E-06 | -9.094E-06 | 7.627E-06 | 2.471 E-07 | 2.345E-06 | -6.403E-06 | -7.994E-06 |
| 26th coefficient (N) | 2.814E-06 | 7.668E-06 | 3.923E-06 | -1.431E-05 | -2.230E-06 | 4.206E-06 | 8.180E-06 |
| 28th coefficient (O) | 0 | 0 | 0 | 0 | 0 | 0 | -4.273E-06 |
| 30th coefficient (P) | 0 | 0 | 0 | 0 | 0 | 0 | 5.989E-07 |
| Conic constant (K) | 63.031 | 54.160 | -94.983 | -4.318 | 15.888 | 44.745 | -11.075 |
| 4th coefficient (A) | -3.786E-01 | -7.946E-01 | -1.214E+00 | -2.449E+00 | -1.271E+00 | -9.662E-01 | -3.086E+00 |
| 6th coefficient (B) | -1.098E-04 | 2.005E-02 | 3.061 E-01 | 5.965E-01 | -2.829E-01 | 7.098E-01 | 7.732E-01 |
| 8th coefficient (C) | 4.584E-03 | 1.772E-02 | -4.394E-02 | 2.929E-02 | 2.865E-01 | -2.619E-01 | -1.894E-01 |
| 10th coefficient (D) | 4.153E-03 | 2.978E-02 | 8.826E-03 | -9.911 E-02 | -1.021 E-01 | 1.794E-01 | 1.221 E-01 |
| 12th coefficient (E) | 1.665E-03 | 9.873E-04 | -1.094E-02 | 3.630E-02 | 3.618E-02 | -1.177E-01 | -4.351 E-02 |
| 14th coefficient (F) | 4.614E-04 | -3.289E-03 | 2.236E-03 | -1.983E-03 | -1.397E-02 | 8.821 E-02 | 2.041 E-02 |
| 16th coefficient (G) | 1.548E-04 | -3.285E-03 | 9.229E-04 | -1.237E-02 | 3.595E-03 | -2.882E-02 | 2.081 E-03 |
| 18th coefficient (H) | -7.180E-05 | -8.215E-04 | 4.171 E-05 | 5.884E-03 | -1.011 E-02 | 6.068E-03 | 1.313E-02 |
| 20th coefficient (J) | 2.354E-05 | 2.783E-04 | -4.445E-04 | 1.593E-03 | -2.892E-03 | 1.339E-02 | 1.635E-03 |
| 22nd coefficient (L) | -5.950E-05 | 3.680E-04 | -7.464E-05 | -2.974E-03 | 2.857E-03 | -2.194E-04 | 6.772E-03 |
| 24th coefficient (M) | 9.795E-06 | 1.318E-04 | 5.892E-05 | 9.667E-05 | 1.596E-03 | -3.067E-03 | 4.967E-03 |
| 26th coefficient (N) | -1.333E-05 | -3.498E-05 | 2.134E-05 | 7.596E-04 | -2.495E-04 | 2.034E-03 | 4.987E-03 |
| 28th coefficient (O) | 2.168E-05 | -4.229E-05 | -1.972E-05 | -1.759E-04 | -3.167E-04 | -1.637E-03 | 2.729E-03 |
| 30th coefficient (P) | -8.962E-06 | -8.168E-06 | 3.036E-06 | -2.200E-04 | -3.555E-05 | -3.942E-04 | 1.091 E-03 |

The optical imaging system configured as above may have aberration properties as in FIG. 10.

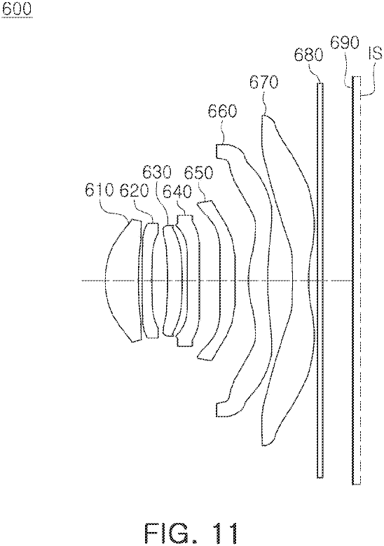

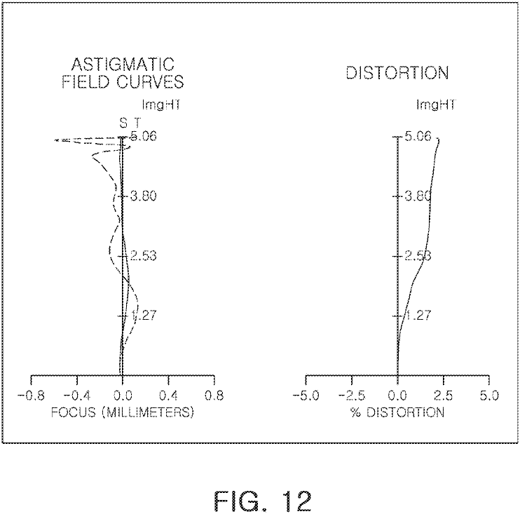

An optical imaging system according to a sixth example embodiment will be described with reference to FIGS. 11 and 12.

The optical imaging system 600 in the sixth example embodiment may include an optical system including a first lens 610, a second lens 620, a third lens 630, a fourth lens 640, a fifth lens 650, a sixth lens 660, and a seventh lens 670, and may further include a filter 680 and an image sensor IS.

The optical imaging system 600 in the sixth example embodiment may form a focus on an imaging plane 690. The imaging plane 690 may refer to a surface on which a focus is formed by the optical imaging system. For example, the imaging plane 690 may refer to one surface of the image sensor IS on which light is received.

The lens properties (a radius of curvature, a thickness of the lens or a distance between the lenses, a refractive index, an Abbe number, and a focal length) of each lens are listed in Table 11.

Table 11

| Surface No. | Note | Radius of curvature | Thickness or distance | Refractive index | Abbe number | Focal length |
|---|---|---|---|---|---|---|
| S1 | First lens | 1.98 | 0.810 | 1.544 | 56.1 | 4.56 |
| S2 | | 8.25 | 0.076 | | | |
| S3 | Second lens | 16.50 | 0.230 | 1.671 | 19.4 | -14.2 |
| S4 | | 6.04 | 0.389 | | | |
| S5 | Third lens | -28.71 | 0.356 | 1.535 | 56.1 | 42.202 |
| S6 | | -13.15 | 0.127 | | | |
| S7 | Fourth lens | 28.49 | 0.300 | 1.671 | 19.4 | -28.786 |
| S8 | | 11.52 | 0.499 | | | |
| S9 | Fifth lens | 15.65 | 0.362 | 1.567 | 38.0 | -32.737 |
| S10 | | 8.44 | 0.327 | | | |
| S11 | Sixth lens | 2.33 | 0.466 | 1.544 | 56.1 | 4.669 |
| S12 | | 25.77 | 0.608 | | | |
| S13 | Seventh lens | -28.19 | 0.391 | 1.535 | 56.1 | -3.742 |
| S14 | | 2.17 | 0.210 | | | |
| S15 | Filter | Infinity | 0.110 | 1.518 | 64.2 | |
| S16 | | Infinity | 0.740 | | | |
| S17 | Imaging plane | Infinity | | | | |

A total focal length f of the imaging optical system 600 in the sixth example embodiment is 5.16 mm, f345 is -23.478 mm, IMG HT is 4.813 mm, SWG31_0.2 is -0.58°, SWG31_0.5 is -2.8°, SWG41_0.3 is 0.68°, SWG42_0.2 is 0.15°, and SWG42 is -2.9°.

In the sixth example embodiment, the first lens 610 may have positive refractive power, the first surface of the first lens 610 may be convex, and the second surface of the first lens 610 may be concave.

The second lens 620 may have negative refractive power, the first surface of the second lens 620 may be convex, and the second surface of the second lens 620 may be concave.

The third lens 630 may have positive refractive power, the first surface of the third lens 630 may be concave, and the second surface of the third lens 630 may be convex.

The fourth lens 640 may have negative refractive power, the first surface of the fourth lens 640 may be convex, and the second surface of the fourth lens 640 may be concave.

The fifth lens 650 may have negative refractive power, the first surface of the fifth lens 650 may be convex in the paraxial region, and the second surface of the fifth lens 650 may be concave in the paraxial region.

Also, at least one inflection point may be formed on at least one of the first and second surfaces of the fifth lens 650. For example, the first surface of the fifth lens 650 may be convex in the paraxial region and may be concave in a portion other than the paraxial region. Also, the second surface of the fifth lens 650 may be concave in the paraxial region and may be convex in a portion other than the paraxial region.

The sixth lens 660 may have positive refractive power, the first surface of the sixth lens 660 may be convex in the paraxial region, and the second surface of the sixth lens 660 may be concave in the paraxial region.

Also, at least one inflection point may be formed on at least one of the first and second surfaces of the sixth lens 660. For example, the first surface of the sixth lens 660 may be convex in the paraxial region and may be concave in a portion other than the paraxial region. Also, the second surface of the sixth lens 660 may be concave in the paraxial region and may be convex in a portion other than the paraxial region.

The seventh lens 670 may have negative refractive power, and the first and second surfaces of the seventh lens 670 may be concave in the paraxial region.

Also, at least one inflection point may be formed on at least one of the first and second surfaces of the seventh lens 670. For example, the first surface of the seventh lens 670 may be concave in the paraxial region and may be convex in a portion other than the paraxial region. Also, the second surface of the seventh lens 670 may be concave in the paraxial region and may be convex in a portion other than the paraxial region.

Each surface of the first lens 610 to the seventh lens 670 may have an aspherical coefficient as listed in Table 12. For example, both the object-side surface and the image-side surface of the first lens 610 to the seventh lens 670 may be aspherical.

Table 12

| | | | | | | | |
|---|---|---|---|---|---|---|---|
| | S1 | S2 | S3 | S4 | S5 | S6 | S7 |
| Conic constant (K) | -0.977 | 18.026 | -85.847 | -2.203 | 99.000 | 82.340 | 99.000 |
| 4th coefficient (A) | 8.077E-02 | -5.774E-02 | 3.585E-02 | 4.363E-02 | -7.745E-02 | -1.335E-01 | -2.705E-01 |
| 6th coefficient (B) | 4.424E-03 | 4.002E-03 | 1.625E-02 | 8.715E-03 | -3.096E-03 | 4.059E-04 | -6.297E-03 |
| 8th coefficient (C) | -3.868E-03 | -2.785E-03 | 1.187E-03 | 1.603E-03 | 3.739E-04 | -7.306 E-04 | -4.041 E-03 |
| 10th | -4.823E-04 | 3.954E-04 | 1.143E-03 | 1.077E-03 | 5.732E-04 | 8.356E-04 | 1.839E-06 |
| coefficient (D) | | | | | | | |
| 12th coefficient (E) | -7.789E-04 | -3.611 E-04 | 6.895E-05 | 3.718E-04 | 1.555E-04 | 7.926E-05 | -2.950E-04 |
| 14th coefficient (F) | 1.220E-04 | 6.883E-05 | -1.331E-05 | 1.741 E-04 | 9.654E-05 | 1.046E-04 | -3.272E-04 |
| 16th coefficient (G) | -1.928E-04 | -8.186E-05 | 2.711 E-05 | 9.921 E-05 | 1.163E-05 | 5.490E-05 | -1.124E-04 |
| 18th coefficient (H) | 1.057E-04 | 3.188E-05 | -3.649E-05 | 2.690E-05 | 2.703E-05 | 8.824E-05 | -5.186E-05 |
| 20th coefficient (J) | -6.351 E-05 | -3.719E-05 | 1.715E-05 | 2.849E-05 | 3.035E-06 | 7.786E-05 | 6.556E-05 |
| 22nd coefficient (L) | 4.757E-05 | 1.177E-05 | -2.079E-05 | -8.476E-06 | 6.761 E-06 | 4.639E-05 | 2.310E-05 |
| 24th coefficient (M) | -3.711 E-05 | -2.631 E-05 | 1.397E-05 | 2.887E-06 | 3.520E-06 | 2.251 E-05 | 6.015E-05 |
| 26th coefficient (N) | 1.265E-05 | 4.237E-06 | -6.628E-06 | -5.854E-06 | 1.810E-06 | 2.766E-05 | 1.828E-05 |
| 28th coefficient (O) | -1.124E-06 | -1.620E-05 | 7.827E-06 | 5.568E-06 | 5.745E-08 | 1.312E-05 | 2.859E-05 |
| 30th coefficient (P) | 2.308E-07 | -3.709E-07 | -4.848E-06 | -7.122E-06 | -4.382E-07 | 1.136E-05 | 1.083E-05 |
| | S8 | S9 | S10 | S11 | S12 | S13 | S14 |
| Conic constant (K) | -15.098 | 21.616 | 1.781 | -1.004 | 33.803 | -89.761 | -1.236 |
| 4th coefficient (A) | -3.128E-01 | -6.778E-01 | -1.126E+00 | -2.770E+00 | -8.776E-01 | -9.057E-01 | -4.812E+00 |
| 6th coefficient (B) | 1.856E-02 | 1.174E-02 | 2.680E-01 | 5.719E-01 | -1.151 E-01 | 5.120E-01 | 1.182E+00 |
| 8th coefficient (C) | 8.719E-03 | 9.061 E-03 | -5.434E-02 | -1.996E-02 | 1.594E-01 | -2.258E-01 | -3.210E-01 |
| 10th coefficient (D) | 7.643E-03 | 2.360E-02 | 2.626E-03 | -4.329E-02 | -4.208E-02 | 1.347E-01 | 1.548E-01 |
| 12th coefficient (E) | 1.409E-03 | 2.678E-03 | -8.204E-03 | 1.946E-02 | 3.334E-02 | -8.288E-02 | -7.902E-02 |
| 14th | 2.652E-04 | -1.279E-03 | 3.649E-03 | -3.993E-03 | -1.363E-02 | 4.977E-02 | 4.099E-02 |
| coefficient (F) | | | | | | | |
| 16th coefficient (G) | -3.440E-04 | -2.667E-03 | -1.490E-04 | -8.540E-03 | -1.335E-02 | -3.127E-02 | -1.805E-02 |
| 18th coefficient (H) | -1.051E-04 | -7.819E-04 | -1.207E-04 | 5.284E-03 | -8.026E-03 | 1.086E-02 | 4.164E-03 |
| 20th coefficient (J) | -1.334E-04 | -1.485E-05 | -4.300E-04 | 9.247E-04 | 3.483E-03 | 1.982E-03 | -5.511 E-03 |
| 22nd coefficient (L) | -2.413E-05 | 1.779E-04 | 3.994E-05 | -2.423E-03 | 1.512E-03 | -6.940E-03 | 7.140E-04 |
| 24th coefficient (M) | -3.352E-05 | 1.327E-04 | 1.081 E-04 | 2.112E-04 | -4.065E-05 | 3.127E-03 | -7.420E-04 |
| 26th coefficient (N) | 1.250E-05 | 1.287E-06 | -6.616E-05 | 3.127E-04 | -5.160E-04 | 4.459E-04 | 7.249E-04 |
| 28th coefficient (O) | -1.930E-05 | 4.966E-06 | -4.369E-05 | 7.144E-05 | 3.702E-04 | -1.486E-03 | -7.613E-04 |
| 30th coefficient (P) | -4.463E-06 | 8.892E-06 | 9.771 E-06 | -1.589E-04 | -6.557E-05 | 4.530E-04 | 3.687E-04 |

The optical imaging system configured as above may have aberration properties as in FIG. 12.

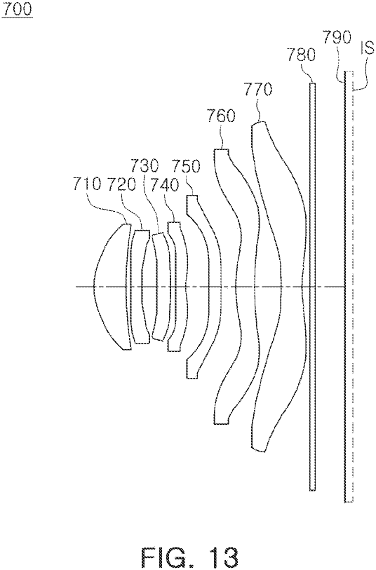

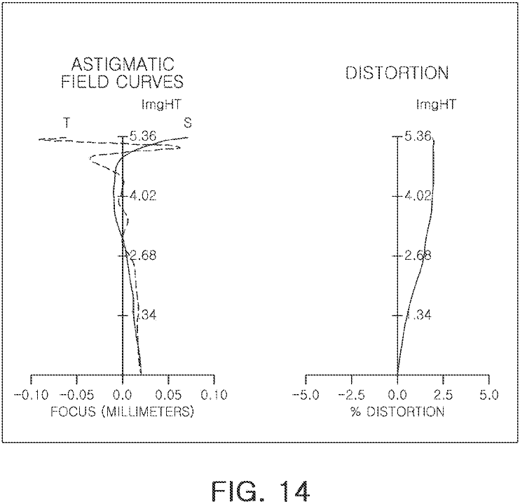

An optical imaging system according to a seventh example embodiment will be described with reference to FIGS. 13 and 14.

The optical imaging system 700 in the seventh example embodiment may include an optical system including a first lens 710, a second lens 720, a third lens 730, a fourth lens 740, a fifth lens 750, a sixth lens 760, and a seventh lens 770, and may further include a filter 780 and an image sensor IS.

The optical imaging system 700 in the seventh example embodiment may form a focus on an imaging plane 790. The imaging plane 790 may refer to a surface on which a focus is formed by the optical imaging system. For example, the imaging plane 790 may refer to one surface of the image sensor IS on which light is received.

The lens properties (a radius of curvature, a thickness of the lens or a distance between the lenses, a refractive index, an Abbe number, and a focal length) of each lens are listed in Table 13.

Table 13

| | | | | | | |
|---|---|---|---|---|---|---|
| Surface No. | Note | Radius of curvature | Thickness or distance | Refractiv e index | Abbe number | Focal length |
| S1 | First lens | 1.98 | 0.803 | 1.544 | 56.1 | 4.573 |
| S2 | | 8.20 | 0.080 | | | |
| S3 | Second lens | 18.54 | 0.280 | 1.671 | 19.4 | -13.39 |
| S4 | | 6.06 | 0.355 | | | |
| S5 | Third lens | -27.25 | 0.351 | 1.567 | 38.0 | 51.729 |
| S6 | | -14.24 | 0.124 | | | |
| S7 | Fourth lens | 18.96 | 0.250 | 1.671 | 19.4 | -77.88 |
| S8 | | 13.88 | 0.526 | | | |
| S9 | Fifth lens | 13.30 | 0.303 | 1.567 | 38.0 | -31.87 |
| S10 | | 7.62 | 0.351 | | | |
| S11 | Sixth lens | 2.87 | 0.471 | 1.544 | 56.1 | 6.03 |
| S12 | | 21.03 | 0.645 | | | |
| S13 | Seventh lens | -51.24 | 0.490 | 1.535 | 56.1 | -4.05 |
| S14 | | 2.28 | 0.210 | | | |
| S15 | Filter | Infinity | 0.110 | 1.518 | 64.2 | |
| S16 | | Infinity | 0.740 | | | |
| S17 | Imaging plane | Infinity | | | | |

A total focal length f of the imaging optical system 700 in the seventh example embodiment is 5.4292 mm, f345 is -41.373 mm, IMG HT is 5.107 mm, SWG31_0.2 is -0.55°, SWG31_0.5 is -2.5°, SWG41_0.3 is 0.55°, SWG42_0.2 is 0.23°, and SWG42 is -3°.

In the seventh example embodiment, the first lens 710 may have positive refractive power, the first surface of the first lens 710 may be convex, and the second surface of the first lens 710 may be concave.

The second lens 720 may have negative refractive power, the first surface of the second lens 720 may be convex, and the second surface of the second lens 720 may be concave.

The third lens 730 may have positive refractive power, the first surface of the third lens 730 may be concave, and the second surface of the third lens 730 may be convex.

The fourth lens 740 may have negative refractive power, the first surface of the fourth lens 740 may be convex, and the second surface of the fourth lens 740 may be concave.

The fifth lens 750 may have negative refractive power, the first surface of the fifth lens 750 may be convex in the paraxial region, and the second surface of the fifth lens 750 may be concave in the paraxial region.

Also, at least one inflection point may be formed on at least one of the first and second surfaces of the fifth lens 750. For example, the first surface of the fifth lens 750 may be convex in the paraxial region and may be concave in a portion other than the paraxial region. Also, the second surface of the fifth lens 750 may be concave in the paraxial region and may be convex in a portion other than the paraxial region.

The sixth lens 760 may have positive refractive power, the first surface of the sixth lens 760 may be convex in the paraxial region, and the second surface of the sixth lens 760 may be concave in the paraxial region.

Also, at least one inflection point may be formed on at least one of the first and second surfaces of the sixth lens 760. For example, the first surface of the sixth lens 760 may be convex in the paraxial region and may be concave in a portion other than the paraxial region. Also, the second surface of the sixth lens 760 may be concave in the paraxial region and may be convex in a portion other than the paraxial region.

The seventh lens 770 may have negative refractive power, and the first and second surfaces of the seventh lens 770 may be concave in the paraxial region.

Also, at least one inflection point may be formed on at least one of the first and second surfaces of the seventh lens 770. For example, the first surface of the seventh lens 770 may be concave in the paraxial region and may be convex in a portion other than the paraxial region. Also, the second surface of the seventh lens 770 may be concave in the paraxial region and may be convex in a portion other than the paraxial region.

Each surface of the first lens 710 to the seventh lens 770 may have an aspherical coefficient as listed in Table 14. For example, both the object-side surface and the image-side surface of the first lens 710 to the seventh lens 770 may be aspherical.

Table 14

| | | | | | | | |
|---|---|---|---|---|---|---|---|
| | S1 | S2 | S3 | S4 | S5 | S6 | S7 |
| Conic constant (K) | -0.885 | 16.204 | 99.000 | 7.315 | -3.393 | 89.760 | -24.751 |
| 4th coefficient (A) | 8.141 E-02 | -5.212E-02 | 1.569E-02 | 3.352E-02 | -6.011 E-02 | -1.113E-01 | -2.404E-01 |
| 6th coefficient (B) | 1.320E-03 | 4.179E-03 | 1.460E-02 | 7.938E-03 | -2.846E-03 | -4.521 E-03 | -8.034E-03 |
| 8th coefficient (C) | -2.449E-03 | -1.952E-03 | 3.940E-05 | 9.837E-04 | 5.051 E-04 | -4.298E-04 | -1.340E-03 |
| 10th coefficient (D) | -1.003E-03 | 8.119E-05 | 9.224E-04 | 8.590E-04 | 4.968E-04 | 1.090E-03 | 9.303E-04 |
| 12th coefficient (E) | -3.957E-04 | -5.197E-05 | 6.506E-05 | 2.727E-04 | 2.948E-04 | 1.931 E-04 | -8.948E-04 |
| 14th coefficient (F) | -8.569E-05 | -1.130E-05 | 2.666E-05 | 1.455E-04 | 8.059E-05 | 4.115E-05 | -8.240E-04 |
| 16th coefficient (G) | -2.891 E-05 | 4.790E-06 | 3.648E-06 | 5.946E-05 | 4.164E-05 | 4.049E-06 | -5.725E-04 |
| 18th coefficient (H) | 5.011 E-06 | -1.138E-06 | -1.008E-05 | 2.901 E-05 | 3.617E-06 | 3.961 E-05 | -2.118E-04 |
| 20th coefficient (J) | -1.020E-07 | 6.258E-07 | -3.853E-06 | 7.921 E-06 | 8.105E-06 | 4.906E-05 | -6.032E-05 |
| 22nd coefficient (L) | -3.343E-06 | -4.451 E-06 | -3.784E-06 | 2.714E-06 | -2.957E-06 | 3.550E-05 | -1.242E-06 |
| 24th coefficient (M) | -2.081 E-06 | 1.097E-06 | 2.782E-06 | -1.480E-06 | 8.437E-07 | 2.781 E-05 | 9.756E-06 |
| 26th coefficient (N) | 9.379E-07 | 1.035E-06 | 1.155E-06 | 1.245E-06 | -4.246E-07 | 1.169E-05 | 9.698E-06 |
| 28th coefficient (O) | 1.695E-06 | 1.968E-06 | 3.050E-06 | -4.384E-07 | 2.084E-06 | 3.009E-06 | 8.467E-06 |
| 30th coefficient (P) | -3.748E-07 | 1.917E-07 | 1.142E-06 | 1.867E-06 | -4.544E-07 | -6.708E-06 | 9.863E-06 |
| | S8 | S9 | S10 | S11 | S12 | S13 | S14 |
| Conic constant (K) | 15.652 | -46.037 | 3.572 | -0.768 | 20.203 | 23.235 | -1.185 |
| 4th coefficient (A) | -2.824E-01 | -6.919E-01 | -1.111E+00 | -2.640E+00 | -9.265E-01 | -9.321 E-01 | -5.085E+00 |
| 6th coefficient (B) | 2.234E-02 | 3.284E-02 | 2.574E-01 | 5.592E-01 | -1.135E-01 | 5.420E-01 | 1.293E+00 |
| 8th coefficient (C) | 1.418E-02 | 1.519E-02 | -5.754E-02 | -2.875E-02 | 1.317E-01 | -2.646E-01 | -3.561 E-01 |
| 10th coefficient (D) | 5.942E-03 | 2.409E-02 | 5.109E-03 | -4.658E-02 | -4.300E-02 | 1.338E-01 | 1.459E-01 |
| 12th coefficient (E) | -8.375E-04 | -2.044E-03 | -8.516E-03 | 2.097E-02 | 3.318E-02 | -7.527E-02 | -8.199E-02 |
| 14th coefficient (F) | -1.159E-03 | -4.552E-03 | 2.945E-03 | -3.989E-03 | -4.613E-03 | 4.749E-02 | 4.133E-02 |
| 16th coefficient (G) | -6.491 E-04 | -2.929E-03 | -1.938E-04 | -3.991 E-03 | -2.725E-03 | -2.661 E-02 | -1.616E-02 |
| 18th coefficient (H) | -5.003E-05 | 1.797E-04 | -1.000E-04 | 4.228E-03 | -4.662E-03 | 8.656E-03 | 9.143E-03 |
| 20th coefficient (J) | 6.762E-05 | 6.370E-04 | -6.225E-04 | -2.492E-04 | -3.783E-04 | -5.445E-04 | -6.954E-03 |
| 22nd coefficient (L) | 6.214E-05 | 2.901 E-04 | 1.314E-04 | -1.192E-03 | 9.293E-04 | -1.745E-03 | 1.387E-03 |
| 24th coefficient (M) | 6.037E-06 | -1.066E-04 | 1.181E-05 | 5.242E-04 | 3.162E-04 | 4.899E-04 | -1.140E-03 |
| 26th coefficient (N) | -6.821 E-06 | -1.430E-04 | -3.535E-05 | 3.670E-04 | 3.613E-04 | 8.407E-04 | 1.099E-03 |
| 28th coefficient (O) | -1.349E-05 | -7.617E-05 | -1.128E-04 | -2.364E-04 | 2.735E-04 | -6.876E-04 | -6.352E-04 |
| 30th coefficient (P) | -1.066E-06 | -3.557E-06 | 6.848E-06 | -8.532E-06 | 1.652E-04 | 2.492E-04 | 3.812E-04 |

The optical imaging system configured as above may have aberration properties as in FIG. 14.

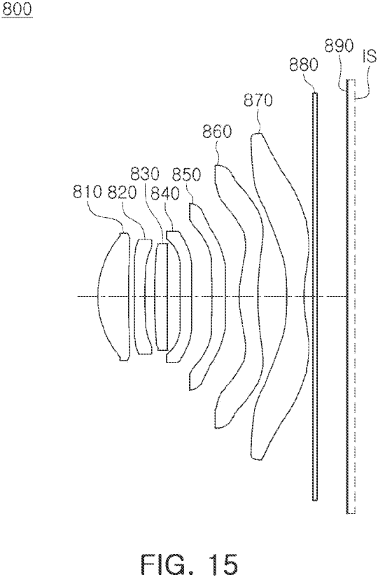

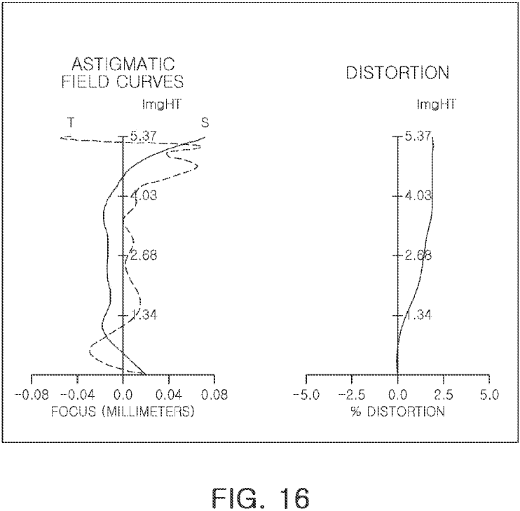

An optical imaging system according to an eighth example embodiment will be described with reference to FIGS. 15 and 16.

The optical imaging system 800 in the eighth example embodiment may include an optical system including a first lens 810, a second lens 820, a third lens 830, a fourth lens 840, a fifth lens 850, a sixth lens 860, and a seventh lens 870, and may further include a filter 880 and an image sensor IS.

The optical imaging system 800 in the eighth example embodiment may form a focus on an imaging plane 890. The imaging plane 890 may refer to a surface on which a focus is formed by the optical imaging system. For example, the imaging plane 890 may refer to one surface of the image sensor IS on which light is received.

The lens properties (a radius of curvature, a thickness of the lens or a distance between the lenses, a refractive index, an Abbe number, and a focal length) of each lens are listed in Table 15.

Table 15

| | | | | | | |
|---|---|---|---|---|---|---|
| Surface No. | Note | Radius of curvature | Thickness or distance | Refractive index | Abbe number | Focal length |
| S1 | First lens | 2.04 | 0.770 | 1.544 | 56.1 | 4.8066 |
| S2 | | 7.91 | 0.150 | | | |
| S3 | Second lens | -687.44 | 0.240 | 1.661 | 20.4 | -11.766 |
| S4 | | 7.96 | 0.252 | | | |
| S5 | Third lens | 7.19 | 0.295 | 1.535 | 56.1 | 30.263 |
| S6 | | 12.71 | 0.325 | | | |
| S7 | Fourth lens | 12.54 | 0.265 | 1.661 | 20.4 | -88.227 |
| S8 | | 10.26 | 0.498 | | | |
| S9 | Fifth lens | 11.35 | 0.333 | 1.567 | 38.0 | -30.329 |
| S10 | | 6.78 | 0.335 | | | |
| S11 | Sixth lens | 2.82 | 0.440 | 1.544 | 56.1 | 5.6647 |
| S12 | | 29.83 | 0.710 | | | |
| S13 | Seventh lens | -729.23 | 0.420 | 1.535 | 56.1 | -4.044 |
| S14 | | 2.18 | 0.206 | | | |
| S15 | Filter | Infinity | 0.110 | 1.518 | 64.2 | |
| S16 | | Infinity | 0.740 | | | |
| S17 | Imaging plane | Infinity | | | | |

A total focal length f of the imaging optical system 800 in the eighth example embodiment is 5.4437 mm, f345 is -118.694 mm, IMG HT is 5.107 mm, SWG31_0.2 is 1.7°, SWG31_0.5 is 3°, SWG41_0.3 is 1.06°, SWG42_0.2 is 0.5°, and SWG42 is -14°.

In the eighth example embodiment, the first lens 810 may have positive refractive power, the first surface of the first lens 810 may be convex, and the second surface of the first lens 810 may be concave.

The second lens 820 may have negative refractive power, the first surface and the second surface of the second lens 820 may be concave.

The third lens 830 may have positive refractive power, the first surface of the third lens 830 may be convex, and the second surface of the third lens 830 may be concave.

The fourth lens 840 may have negative refractive power, the first surface of the fourth lens 840 may be convex, and the second surface of the fourth lens 840 may be concave.

The fifth lens 850 may have negative refractive power, the first surface of the fifth lens 850 may be convex in the paraxial region, and the second surface of the fifth lens 850 may be concave in the paraxial region.

Also, at least one inflection point may be formed on at least one of the first and second surfaces of the fifth lens 850. For example, the first surface of the fifth lens 850 may be convex in the paraxial region and may be concave in a portion other than the paraxial region. Also, the second surface of the fifth lens 850 may be concave in the paraxial region and may be convex in a portion other than the paraxial region.

The sixth lens 860 may have positive refractive power, the first surface of the sixth lens 860 may be convex in the paraxial region, and the second surface of the sixth lens 860 may be concave in the paraxial region.

Also, at least one inflection point may be formed on at least one of the first and second surfaces of the sixth lens 860. For example, the first surface of the sixth lens 860 may be convex in the paraxial region and may be concave in a portion other than the paraxial region. Also, the second surface of the sixth lens 860 may be concave in the paraxial region and may be convex in a portion other than the paraxial region.

The seventh lens 870 may have negative refractive power, and the first and second surfaces of the seventh lens 870 may be concave in the paraxial region.

Also, at least one inflection point may be formed on at least one of the first and second surfaces of the seventh lens 870. For example, the first surface of the seventh lens 870 may be concave in the paraxial region and may be convex in a portion other than the paraxial region. Also, the second surface of the seventh lens 870 may be concave in the paraxial region and may be convex in a portion other than the paraxial region.

Each surface of the first lens 810 to the seventh lens 870 may have an aspherical coefficient as listed in Table 16. For example, both the object-side surface and the image-side surface of the first lens 810 to the seventh lens 870 may be aspherical.

Table 16

| | | | | | | | |
|---|---|---|---|---|---|---|---|
| | S1 | S2 | S3 | S4 | S5 | S6 | S7 |
| Conic constant (K) | -1.325 | 4.090 | -99.000 | 9.555 | 14.859 | 81.047 | -5.002 |
| 4th coefficient (A) | 6.056E-02 | -8.910E-02 | 3.539E-02 | 4.242E-02 | -5.993E-02 | -9.299E-02 | -2.776E-01 |
| 6th coefficient (B) | -1.584E-02 | -2.102E-03 | 1.794E-02 | 1.314E-02 | 6.301 E-03 | 4.246E-03 | -1.913E-02 |
| 8th coefficient (C) | -6.731 E-03 | -1.657E-03 | -8.596E-04 | -8.585E-05 | 1.130E-03 | 1.745E-03 | -1.574E-03 |
| 10th coefficient (D) | -1.425E-03 | 7.433E-05 | 1.022E-03 | 7.970E-04 | 5.213E-04 | 1.145E-03 | 1.412E-03 |
| 12th coefficient (E) | -1.867E-04 | 1.329E-05 | -1.096E-04 | 8.602E-05 | 1.320E-04 | 4.297E-04 | 8.556E-04 |
| 14th coefficient (F) | 1.058E-04 | -4.371 E-05 | 6.135E-06 | 3.855E-05 | 1.686E-05 | 2.101 E-04 | 4.849E-04 |
| 16th coefficient (G) | 2.572E-05 | 1.250E-05 | -1.344E-05 | 8.777E-06 | 1.811 E-05 | 7.707E-05 | 1.655E-04 |
| 18th coefficient (H) | 2.183E-05 | -1.460E-05 | -5.088E-07 | -1.962E-07 | -1.221 E-05 | 3.453E-05 | 4.144E-05 |
| 20th coefficient (J) | -7.606E-06 | 7.434E-06 | -3.411 E-06 | -1.238E-06 | 4.771 E-06 | 1.376E-05 | 1.123E-05 |
| 22nd coefficient (L) | 1.950E-06 | -3.948E-06 | 4.341 E-08 | -7.578E-07 | -5.632E-06 | 1.107E-05 | -8.085E-06 |
| 24th coefficient (M) | -2.918E-06 | 3.562E-06 | -3.456E-06 | 6.750E-07 | 2.290E-06 | 3.113E-06 | 2.270E-07 |
| 26th coefficient (N) | 1.109E-06 | -4.411 E-07 | 8.239E-07 | 6.401 E-08 | -5.783E-07 | 5.472E-06 | -9.539E-06 |
| 28th coefficient (O) | -2.392E-06 | 2.808E-06 | -8.407E-08 | 2.339E-07 | 4.241 E-06 | 2.497E-06 | -2.972E-06 |
| 30th coefficient (P) | 1.131 E-06 | -1.797E-06 | 1.654E-06 | -4.060E-07 | -2.152E-06 | 3.073E-06 | -5.005E-06 |
| Conic constant (K) | -34.753 | -51.230 | -0.156 | -0.870 | 82.234 | 99.000 | -1.193 |
| 4th coefficient (A) | -3.676E-01 | -7.659E-01 | -1.220E+00 | -2.452E+00 | -9.456E-01 | -1.330E+00 | -5.051E+00 |
| 6th coefficient (B) | 1.405E-03 | 7.072E-02 | 3.070E-01 | 4.319E-01 | -1.500E-01 | 6.906E-01 | 1.288E+00 |
| 8th coefficient (C) | 1.318E-02 | 2.261 E-02 | -6.545E-02 | 7.656E-02 | 2.249E-01 | -3.027E-01 | -3.611 E-01 |
| 10th coefficient (D) | 9.262E-03 | 2.370E-02 | 6.293E-03 | -6.905E-02 | -7.514E-02 | 1.089E-01 | 1.211E-01 |
| 12th coefficient (E) | 2.549E-03 | -3.558E-03 | -3.988E-03 | 3.448E-03 | 2.902E-02 | -4.673E-02 | -7.373E-02 |
| 14th coefficient (F) | 4.573E-04 | -4.464E-03 | 2.707E-03 | -3.785E-03 | -1.956E-02 | 3.730E-02 | 4.059E-02 |
| 16th coefficient (G) | -5.338E-04 | -3.052E-03 | -1.399E-03 | -8.727E-04 | -1.035E-02 | -2.788E-02 | -1.777E-02 |
| 18th coefficient (H) | -4.348E-04 | -6.086E-04 | -6.042E-04 | 2.225E-03 | -6.935E-03 | 1.356E-02 | 1.013E-02 |
| 20th coefficient (J) | -2.927E-04 | 7.111 E-04 | 2.505E-04 | -1.215E-03 | 3.225E-04 | -6.462E-04 | -4.604E-03 |
| 22nd coefficient (L) | -1.163E-04 | 4.878E-04 | -1.880E-04 | -2.922E-03 | 2.311 E-03 | -2.887E-03 | 1.745E-03 |
| 24th coefficient (M) | -4.988E-05 | 1.190E-04 | -2.268E-04 | 2.011 E-04 | 1.053E-03 | 1.417E-03 | 2.745E-06 |
| 26th coefficient (N) | -5.730E-06 | -1.763E-04 | -2.312E-05 | 4.012E-04 | 2.322E-05 | 3.093E-04 | 1.201 E-03 |
| 28th coefficient (O) | -1.565E-06 | -1.225E-04 | 5.351 E-05 | -2.575E-04 | -1.721E-04 | -7.169E-04 | -6.606E-04 |
| 30th coefficient (P) | 5.193E-06 | -8.719E-05 | -2.805E-05 | -4.055E-04 | -2.157E-04 | 2.192E-04 | 2.703E-04 |

The optical imaging system configured as above may have aberration properties as in FIG. 16.

According to the aforementioned example embodiments, the optical imaging system may implement high resolution and may have a reduced size.

While specific example embodiments have been illustrated and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system, comprising:
a first lens, a second lens, a third lens, a fourth lens, a fifth lens, a sixth lens and a seventh lens, disposed in order from an object side,
wherein the first lens has positive refractive power, and the second lens has negative refractive power, and
wherein 0.5 < TTL/(2x IMG HT) < 0.67 is satisfied, where TTL is a distance from an object-side surface of the first lens to an imaging plane on an optical axis, and IMG HT is half a diagonal length of the imaging plane.

2. The optical imaging system of claim 1, wherein 4.5 mm < IMG HT < 6.5 mm is satisfied.

3. The optical imaging system of claim 1, wherein TTL/ΣCT < 2.97 is satisfied, where ΣCT is a sum of thicknesses of the first to seventh lenses on the optical axis.

4. The optical imaging system of claim 1, wherein -0.2 < f/f4 < 0 is satisfied, where f is a total focal length of the optical imaging system, and f4 is a focal length of the fourth lens.

5. The optical imaging system of claim 1, wherein v1-v2 < 38 and n2+n4 > 3.3 are satisfied, where v1 is an Abbe number of the first lens, v2 is an Abbe number of the second lens, n2 is a refractive index of the second lens, and n4 is a refractive index of the fourth lens.

6. The optical imaging system of claim 1, wherein TTL/f < 1.205 and BFL/f < 0.21 are satisfied, where BFL is a distance from an image-side surface of the seventh lens to the imaging plane on the optical axis, and f is a total focal length of the optical imaging system.

7. The optical imaging system of claim 1, wherein -0.02 < CT4/f4 < 0 is satisfied, where CT4 is a thickness of the fourth lens on the optical axis, and f4 is a focal length of the fourth lens.

8. The optical imaging system of claim 1, wherein -0.5 < R8/f4 < 0 is satisfied, where R8 is a radius of curvature of an image-side surface of the fourth lens, and f4 is a focal length of the fourth lens.

9. The optical imaging system of claim 1, wherein -20° < SWG42 ≤-2.9° is satisfied, where SWG42 is a sweep angle at a maximum effective diameter of an image-side surface of the fourth lens.

10. The optical imaging system of claim 1, wherein 0° < SWG41_0.3 < 1.1° is satisfied, where SWG41_0.3 is a sweep angle at a point of a maximum effective diameter x 0.3 of an object-side surface of the fourth lens.

11. The optical imaging system of claim 1, wherein -0.5° < SWG42_0.2 < 0.6° is satisfied, where SWG42_0.2 is a sweep angle of a point of a maximum effective diameter x 0.2 of an image-side surface of the fourth lens.

12. The optical imaging system of claim 1, wherein -3° < SWG31_0.5 ≤ 3° is satisfied, where SWG31_0.5 is a sweep angle at a point of a maximum effective diameter x 0.5 of an object-side surface of the third lens.

13. The optical imaging system of claim 1, wherein -1° < SWG31 0.2 < 2° is satisfied, where SWG31 0.2 is a sweep angle of a point of a maximum effective diameter x 0.2 of an object-side surface of the third lens.

14. The optical imaging system of claim 1, wherein 0.3 < |f1/f2| < 0.45 is satisfied, where f1 is a focal length of the first lens, and f2 is a focal length of the second lens.

15. The optical imaging system of claim 1, wherein 20 mm < |f345| < 120 mm and 4 < |f345|/f < 25 are satisfied, where f345 is a combined focal length of the third to fifth lenses, and f is a total focal length of the optical imaging system.

16. The optical imaging system of claim 1, wherein the third lens has positive refractive power, the fourth lens has negative refractive power, the fifth lens has negative refractive power, the sixth lens has positive refractive power, and the seventh lens has negative refractive power.

17. An optical imaging system, comprising:
a first lens having positive refractive power;
a second lens having negative refractive power;
a third lens having refractive power;
a fourth lens having refractive power;
a fifth lens having refractive power;
a sixth lens having positive refractive power and a concave image-side surface; and
a seventh lens having refractive power and a concave object-side surface,
wherein the first lens, the second lens, the third lens, the fourth lens, the fifth lens, the sixth lens and the seventh lens are disposed in this order from an object side, and
wherein -0.2 < f/f4 < 0 is satisfied, where f is a total focal length of the optical imaging system, and f4 is a focal length of the fourth lens.

18. The optical imaging system of claim 17, wherein 0.5 < TTL/(2xIMG HT) < 0.67 is satisfied, where TTL is a distance from an object-side surface of the first lens to an imaging plane on an optical axis, and IMG HT is half a diagonal length of the imaging plane.

19. The optical imaging system of claim 17, wherein TTL/ΣCT < 2.97 is satisfied, where ΣCT is a sum of thicknesses of the first to seventh lenses on the optical axis.

20. An optical imaging system, comprising:
a first lens having positive refractive power;
a second lens having negative refractive power and a concave object-side surface;
a third lens having refractive power;
a fourth lens having refractive power;
a fifth lens having refractive power;
a sixth lens having refractive power; and
a seventh lens having refractive power,
wherein the first lens, the second lens, the third lens, the fourth lens, the fifth lens, the sixth lens and the seventh lens are disposed in this order from an object side, and
wherein v1-v2 < 38 and n2+n4 > 3.3 are satisfied, where v1 is an Abbe number of the first lens, v2 is an Abbe number of the second lens, n2 is a refractive index of the second lens, and n4 is a refractive index of the fourth lens.
